(19) United States
(12) Patent Application Publication
(10) Pub. No.: US 2022/0121551 A1
(43) Pub. Date: Apr. 21, 2022

(54) METHOD AND DEVICE FOR CALCULATING RUNTIME OF NEURAL NETWORK ON PROCESSOR

(71) Applicant: Shenzhen Intellifusion Technologies Co., Ltd., Shenzhen (CN)

(72) Inventor: Dong Wang, Shenzhen (CN)

(21) Appl. No.: 17/503,390

(22) Filed: Oct. 18, 2021

(30) Foreign Application Priority Data
Oct. 20, 2020 (CN) 202011121738.5

(51) Int. Cl. G06F 11/34; G06N 3/04

(52) U.S. Cl. CPC G06F 11/3466; G06N 3/04

(57) ABSTRACT

A method and a device for calculating a runtime of a neural network on a processor relate to artificial intelligence (AI) technology fields for improving compilation efficiency of a compiler. The method includes: obtaining data read-write time information and data processing time information of each network layer in a to-be-compiled neural network, according to tiling information of the neural network on the processor, and determining a time value of each network layer according to the data read-write time information and the data processing time information of each network layer, wherein the tiling information indicates that a plurality of network layers in the neural network are divided into M network layer groups, M is an integer more than and equal to one, each network layer group including at least one network layer; adding the time value of each network layer, to obtain a time value of the processor for operating the neural network.

### 1. TECHNICAL FIELD

The present disclosure generally relates to artificial intelligence (AI) technology fields, and especially relates to a method and a device for calculating a runtime of a neural network on a processor.

### 2. DESCRIPTION OF RELATED ART

Neural network is widely used in various fields based on deep learning, so that processing performance of a processor for performing the neural network is more and more demanded. In order to improve the processing performance of the processor, a compiler is configured to perform tiling processing on the neural network (that is, grouping network layers in the neural network) before the neural network with specific functions is compiled by a general processor or a dedicated processor, so as to reduce access frequency that the processor with the specific function that has been compiled accesses with an external memory, thereby improving the processing performance of the processor.

As the neural network becomes larger and larger, more and more tiling modes can be used to tile the same neural network. In order to provide a tiling mode capable of optimizing the processing performance of the processor from a plurality of tiling modes, the compiler is generally needed to compile one by one according to each tiling mode to obtain a plurality of processors with the same functions. Then each processor is measured to select a tiling mode with the optimal processing performance to deploy the processors. However, it is needed to take a long time to compile by such way, resulting in very low compilation efficiency.

### SUMMARY

The technical problems to be solved: in view of the shortcomings of the related art, the present disclosure relates to a method and a device for calculating a runtime of a neural network on a processor thereof which can improve compilation efficiency of a compiler.

In order to implement the above purposes, in a first respect, a method for calculating a runtime of a neural network on a processor according to an embodiment of the present disclosure includes:

obtaining data read-write time information and data processing time information of each network layer in a to-be-compiled neural network, according to tiling information of the neural network on a processor, and determining a time value of each network layer according to the data read-write time information and the data processing time information of each network layer; wherein the tiling information is configured to indicate that a plurality of network layers in the neural network are divided into M network layer groups, M is an integer more than and equal to one, and each network layer group includes at least one network layer group; and

adding the time value of each network layer of the neural network, to obtain a time value of the processor for operating the neural network.

In a second respect, a device for calculating a runtime of a neural network on a processor according to an embodiment of the present disclosure includes:

an evaluation unit configured to obtain data read-write time information and data processing time information of each network layer in a to-be-compiled neural network, according to tiling information of the neural network on the processor, and determine a time value of each network layer according to the data read-write time information and the data processing time information of each network layer, wherein the tiling information is configured to indicate that a plurality of network layers in the neural network are divided into M network layer groups, M is an integer more than and equal to one, and each network layer group includes at least one network layer; and

a superposition unit configured to add the time value of each network layer of the neural network, to obtain a time value of the processor for operating the neural network.

In a third respect, a compiler according to an embodiment of the present disclosure includes a memory configured to store computer programs, and a processor configured to perform the computer programs to implement the method above mentioned in the first aspect or any of the embodiments of the first aspect.

In a fourth respect, a computer readable storage medium according to an embodiment of the present disclosure is configured to store computer programs performed by a processor to implement the method above mentioned in the first aspect or any of the embodiments of the first aspect.

In the method and the device for calculating the runtime of the neural network on the processor of the present disclosure, after the neural network is compiled by the processor based on the tiling information, the processor is configured to perform the data read-write time information and the data processing time information of each network layer, when the neural network is compiled on the processor according to the tiling mode, a time value that the processor performs the neural network can be estimated. The time value of the processor corresponding to each tiling mode can be estimated without compiling the neural network based on such time cost estimation method. And then, a tiling mode with a part of relatively smaller time value or with a time value smaller than a time cost threshold can be selected from a large number of tiling modes for compiling and deploying to obtain a corresponding processor, based on the time value of each processor. Then the processor is measured to determine the tiling mode used by the processor with the optimal processing performance, rather than needing to compile each tiling mode one by one. Thus, the compilation efficiency can be greatly improved.

### BRIEF DESCRIPTION OF THE DRAWINGS

FIG. 1 is a schematic diagram of a processor in accordance with an embodiment of the present disclosure.

FIG. 2 is a schematic diagram of a processing element (PE) in accordance with an embodiment of the present disclosure.

FIG. 3 is a schematic diagram of data streams in accordance with an embodiment of the present disclosure.

FIG. 4 is a schematic diagram of a neural network in accordance with an embodiment of the present disclosure.

FIG. 5 is a tiling schematic diagram of tiling slices in accordance with an embodiment of the present disclosure.

FIG. 6 is a tiling schematic diagram of a layer group (LG) in accordance with an embodiment of the present disclosure.

FIG. 7 is a tiling schematic diagram of the layer group (LG) of the neural network of FIG. 4.

FIG. 8 is a flowchart of a method for calculating a runtime of a neural network on a processor in accordance with an embodiment of the present disclosure.

FIG. 9 is a flowchart of determining fourth time information in accordance with an embodiment of the present disclosure.

FIG. 10A is a flowchart of determining data processing time information in accordance with an embodiment of the present disclosure.

FIG. 10B is a schematic diagram of a convolution calculation process of seven pixel points in an output feature map in accordance with an embodiment of the present disclosure.

FIG. 11 is a schematic diagram of a device for calculating a runtime of a neural network on a processor in accordance with an embodiment of the present disclosure.

FIG. 12 is a schematic diagram of a compiler in accordance with an embodiment of the present disclosure.

### DETAILED DESCRIPTION

In order to conveniently understand the technical solutions of the present disclosure, a processor and some terminologies involved in an embodiment of the present disclosure are explained below in conjunction with attached drawings.

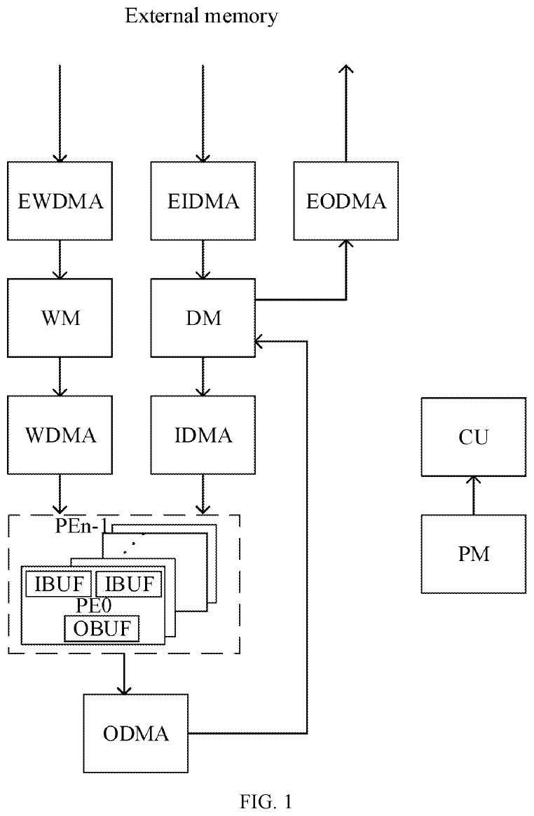

Referring to FIG. 1, a schematic diagram of a processor in accordance with an embodiment of the present disclosure is provided. The processor generally includes a plurality of functional units (FUs), a control unit (CU), and an on-chip memory. The plurality of FUs is loosely coupled and cooperated with each other to perform a plurality of interdependent data-streaming operations and data calculation in parallel under a control of the control unit. Both the control unit and the functional unit can be programmed.

The plurality of FUs can include a plurality of processing elements (PEs) and a Direct Memory Access (DMA) unit. For example, FIG. 1 shows that the processor includes n (n is an integer greater than and equal to one) PEs, respectively PE1, PE2, . . . , PEn−2, and PEn−1. The DMA unit can include a first DMA unit (that is, an external input DMA, hereinafter representing by EIDMA), a second DMA unit (that is, an external parameter DMA, hereinafter representing by EWDMA), a third DMA unit (that is, an input DMA, hereinafter representing by IDMA), a fourth DMA unit (that is, a parameter DMA, hereinafter representing by WDMA), a fifth DMA unit element (that is, an output DMA, hereinafter representing by ODMA), and a sixth DMA unit (that is, an external output DMA, hereinafter representing by EODMA).

The EIDMA, the EWDMA, and the EODMA are configured to implement data transmission between the processor and an external memory of the processor. The IDMA, the WDMA, and the ODMA are configured to implement data transmission within the processor.

The on-chip memory can be a Static Random-Access Memory (SRAM), and specifically can include a Data Memory (DM) configured to store data, a Weight Memory (WM) configured to store parameters of the neural network, and a Program Memory (PM) configured to store computer programs. The CU can be configured to coordinate and control a whole operation of the processor by invoking data stream instructions stored in the PM, so as to perform data processing of the neural network.

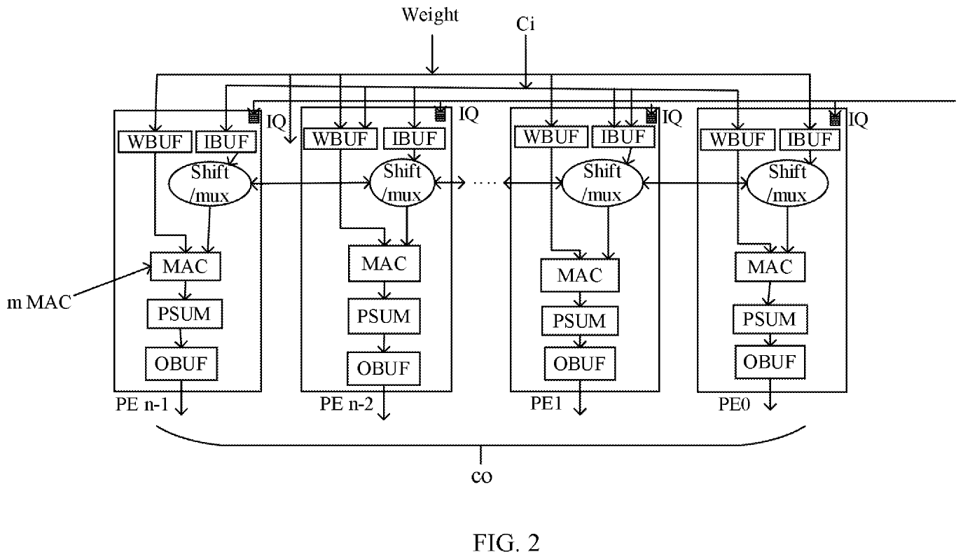

Referring to FIG. 2, a schematic diagram of a processing element (PE) in accordance with an embodiment of the present disclosure is shown. The PE includes an Instruction Queue (IQ), m (m is an integer greater than and equal to one) Multiply Accumulate (MAC) modules, a shift selection logic (shift/mux) module, a partial sum (PSUM) module and a cache.

Furthermore, the IQ is configured to cache instructions sent by the CU, and the PE is configured to extract the instructions from the IQ and then perform the instructions in a queue order to finish data stream operations and data calculation processing. The shift/mux module is configured to obtain data from the cache, send the data to an adjacent PE and receive the data sent by the adjacent PE, perform left shift or right shift on the data, and finally send the data that has been shifted to the MAC module. The MAC module is configured to perform a multiplication and addition operation on input data. The PSUM module is configured to perform a partial sum calculation on results output from the m MAC modules to obtain output data. The cache can include a parameter buffer (WBUF) configured to cache parameters, an input buffer (IBUF) configured to cache the input data, and an output buffer (OBUF) configured to cache the output data.

The plurality of PEs is connected therebetween through a bus. Each PE can independently perform instruction extraction, instruction decoding and instruction execution, and can independently perform a Convolution Neuron Network (CNN) calculation operation, or can combine a PE group with an adjacent PE group to jointly perform the CNN calculation operation. The so-called CNN calculation operation includes a convolution operation, a pooling operation and an activation operation.

For example, the processor of the present disclosure can be a loose-coupled data-streaming convolution processor (LSN), or other types of processors.

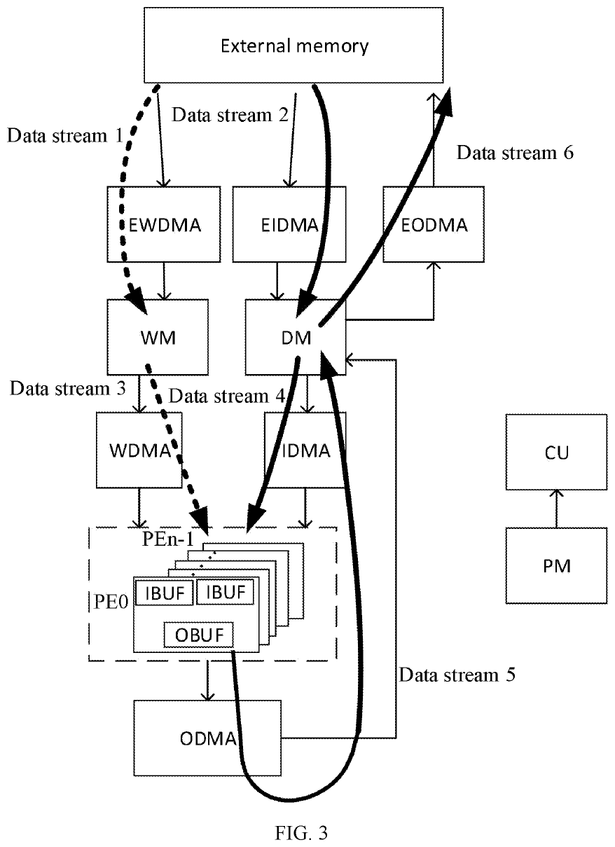

At least six data stream operations are set for the processor, data streams of the processor can be illustratively described below in conjunction with FIG. 3. As shown in FIG. 3, the six data stream operations are respectively:

a data stream 1, the EIDMA transmits input data stored in the external memory to the DM.

A data stream 2, the IDMA transmits the input data stored in the DM to all PEs that need to process the input data. The IDMA transmits the input data to the IBUF of each PE by a broadcasting mode.

A data stream 3, the ODMA transmits output data stored in the OBUF of the PE to the DM. For an operation of the data stream 3, the PE synchronously writes the output data (that is, the PE obtains the data that has been processed by the MAC module, the shift/mux module and the PSUM module) back to the DM through a lockstep mode.

A data stream 4, the EODMA transmits the output data from the PE to the external memory.

A data stream 5, the EWDMA transmits the parameters stored in the external memory to the WM.

A data stream 6, the WDMA transmits the parameters stored in the WM to the WBUF.

In the above data stream operations, feature maps stored in the DM can be read by the EIDMA from the external memory, or can be read by the ODMA from the OBUF of the PE. The feature maps stored in the DM can be transmitted to the external memory by the EODMA as the input data of a next network layer or an output result of the neural network, can also be transmitted directly from the IDMA to the IBUF of the PE as the input data of a next network layer.

In the field of artificial intelligence, the neural network is a mathematical model composed of a large number of operations (ops), and configured to perform information processing of corresponding functions (e.g., classification, tracking, recognition, etc.) through complex connection relationships between the ops. Each neuron in the neural network is an operation (op), such as a convolution operation, a pooling operation and an activation operation. The neural network is divided into a plurality of network layers based on the connection relationship of the ops, such as an input layer, an output layer, a convolution layer, and a fully-connected layer. One network layer usually includes at least one op. An input of each network layer (including input data and parameters) can flow through the processor through the above six data stream operations, so as to obtain the output data of the network layer that has been processed by the PE.

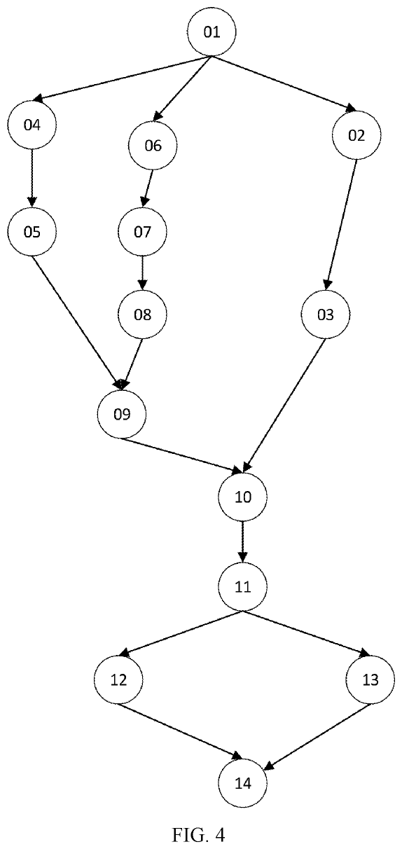

Furthermore, data dependencies are between a plurality of network layers. Output data of a previous network layer can be input data of a next network layer, that is, an input of the next network layer depends on an output of the previous network layer. For example, the neural network shown in FIG. 4 includes fourteen network layers with L01 to L14. L09, L10, L11 and L12 are taken as examples, input data of L09 includes output data of L02 and output data of L06. The input data and parameters of L09 can flow through the processor via the above six data streams, and output data of L09 can be obtained that is processed by the PE. The output data of L09 is taken as input data of L10, together with parameters of L10, flows through the processor via the above six data streams to obtain output data of L10 that has been processed by the PE. Correspondingly, the output data of L10 can be taken as input data of L11 and L12.

In the present disclosure, the input data can be described by three dimensions: the number of input feature channels c1, a width w1 and a height h1. Furthermore, c1 represents the number of input feature maps (hereinafter representing by ci). Each ci is a matrix with a width w1 and a height h1. The input data includes cl matrices of w1×h1.

Correspondingly, the output data can be described by three dimensions: the number of output feature channels c2, a width and a height, c2 represents the number of output feature maps (hereinafter, representing by co). Each co is a matrix with a width w2 and a height h2. The input data includes c2 matrices of w2×h2, and units of both the width w2 and the height h2 are pixels (pixels, p).

The parameters of the network layer include a weight required by each layer of network layer when performing calculation from the input data to the output data. Each weight is a convolution kernel (it can also be a CNN filter of the neural network), that can be obtained based on training the neural network.

Since each PE includes m MAC modules, each PE can be configured to perform single-instruction multiple-data stream (SIMD) processing with a width of m. Data of the m MAC modules is input to form a data vector with a length of m, and n data vectors of n PEs can form a long data vector with a length of nm. The long data vector can be obtained that the shift/mux module of the n PEs shifts to the right or to the left. The data vectors that have been shifted are then sent to the nm MAC modules of the n PEs.

Correspondingly, the DM is organized according to a structure of the PE. The DM is tiled into n DM slices based on the number of PEs, and a width of each DM slice is m based on the number of MAC modules in each PE. That is, a total width of the DM is nm data, and the DM slices are mapped to the PEs one by one. Each data in the DM can be uniquely mapped to a corresponding MAC module in each PE.

When a width of the feature map (ci or co) of a certain network layer is greater than nm, the feature map can be vertically tile into a plurality of vertical slices (tile). The processor can be configured to process the plurality of vertical slices in sequence, one tile at a time. When a height of co is higher than that of the OBUF, co can be horizontally tile into a plurality of horizontal slices (tile); when the width of the feature map (ci or co) is greater than nm and the height of co is greater than that of the OBUF, ci or co can be vertically and horizontally tiled at the same time.

Three tiling modes are illustrated below:

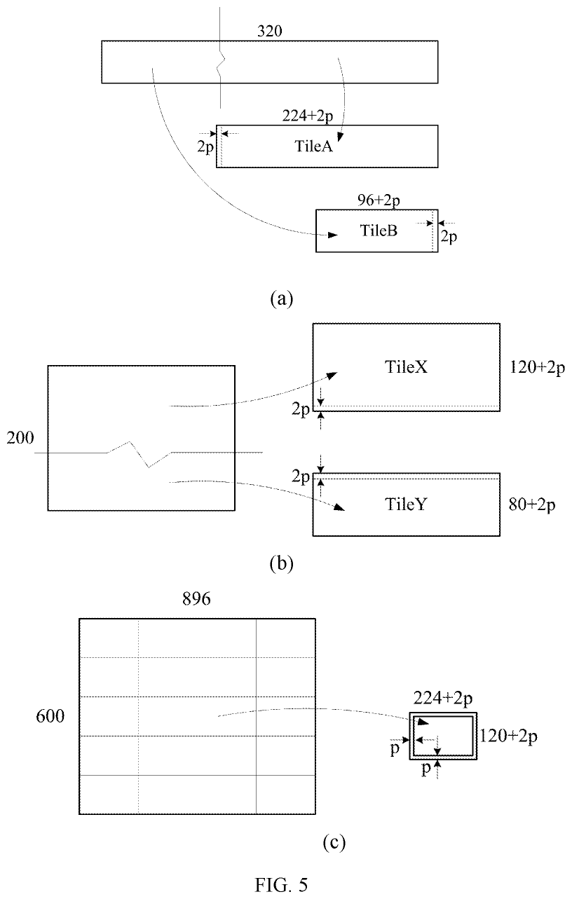

FIG. 5 (a) is a tiling schematic diagram of a vertical tiling slice provided in an embodiment of the present disclosure, as shown in FIG. 5 (a), it is assumed that nm is 224p and a width of ci of a certain network layer is 320p. Due to 320 greater than 224, the compiler is configured to vertically tile the ci into two slices. A width of one of the two slices (TileA) is 224+2p pixels and a width of the other of the two slices (TileB) is 96+2p pixels. A shrinking size 2p is formed between input and output during tiling the two slices, and each slice can be configured to be increased with one shrinking size in order to ensure integrity of data. Both the TileA and the TileB are sequentially calculated and processed by the PE.

FIG. 5 (b) is a tiling schematic diagram of a horizontal tiling slice provided in the embodiment of the present disclosure, as shown in FIG. 5 (b), it is assumed that a height of the ci of the certain network layer is 200p, and a maximum height supported by the OBUF is 128p. The compiler is configured to horizontally tile the ci into two slices. A height of one of the two slices (TileX) is 120+2p pixels and a height of the other of the two slices (TileY) is 80+2p pixels.

FIG. 5 (c) is a tiling schematic diagram of a tiling slice in both horizontal and vertical directions provided in the embodiment of the present disclosure, as shown in FIG. 5 (c), it is assumed that a size of the ci of the certain network layer is 896×600p, a width of the ci exceeds a maximum (224p) of nm, and a height of the ci exceeds a maximum (128p) supported by the OBUF. Therefore, the compiler vertically tiles the ci into four slices and horizontally tiles the ci into five slices, i.e., twenty slices in total, and a size of each slice can be (224+2p)×(120+2p) pixels. In the example, each slice shares parameters with four adjacent slices (located above, below, left, and right of the slice, respectively).

It should be noted that, the number of slices in each above tiling mode is exemplified by taking a minimum number of slices to be tiled as an example, and more slices can be tiled during specific tilings.

When the ci of a plurality of consecutive network layers are needed to be tiled, the compiler is usually configured to combine the plurality of contiguous network layers into a network layer group (LG), and then tile the ci of the LG. It is to be understood that an input of a next layer is an output of a previous layer in each network layer of the LG. Then, tiling the ci of the LG is meant to tile the ci of a first network layer in the LG.

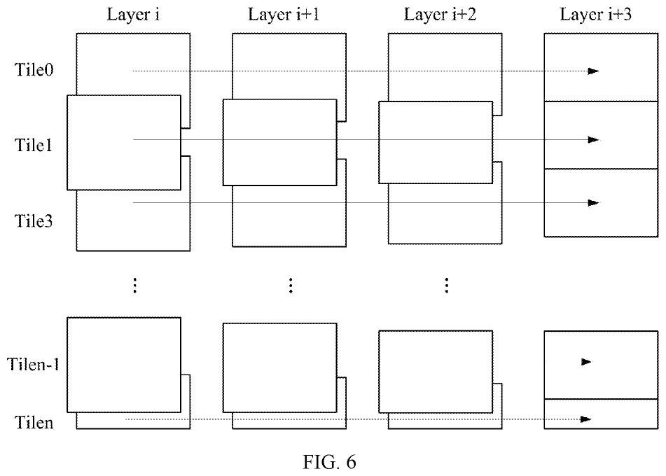

For example, FIG. 6 is a tiling schematic diagram of a layer group (LG) in accordance with an embodiment of the present disclosure. As shown in FIG. 6, it is assumed that all network layers named as a Layer i, a Layer (i+1), and a Layer (i+2) exceed a support range of the processor, the compiler is configured to tile the Layer i, the Layer (i+1), and the Layer (i+2) into a single LG, and then tile input data (that is, input data of the Layer i) of the LG to obtain (N+1) slices (Tile0, Tile1, Tile2 . . . Tile(n−1), Tilen). In order to ensure access frequency between the processor and the external memory, each slice of the LG is sequentially processed in the Layer i, the Layer (i+1) and the Layer (i+2), respectively, and then processing results of the slices are spliced on the external memory to form input data of a Layer (i+3).

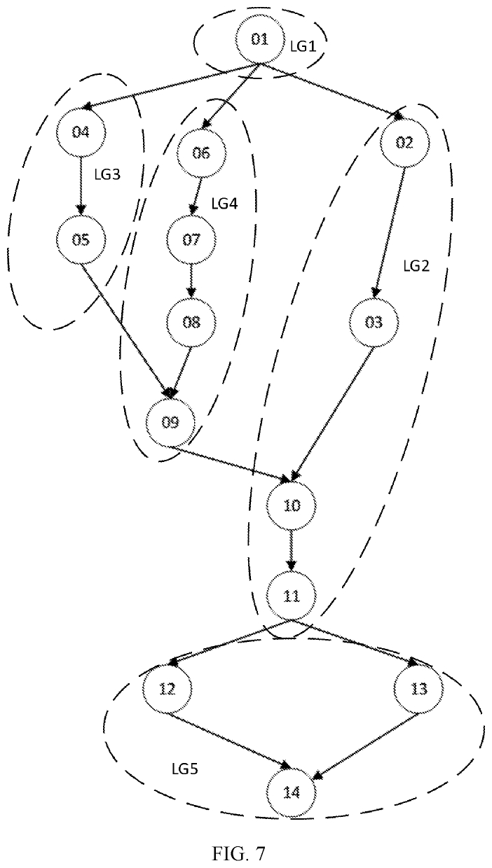

It is understood that, the neural network shown in FIG. 4 is tiled according to different tiling modes based on a tiling principle of the LG. For example, the neural network can be tiled into four LGs: LG 1˜LG 4 according to the tiling mode of FIG. 7. The LG 1 includes one layer of network layer: L01. The LG 2 includes four layers of network layers: L02, L03, L10 and L11. The LG 3 includes six layers of network layers: L04-L09. The LG 4 includes three layers of network layers: L12-L14. For another example, the neural network can also be tiled into eight LGs: LG 1-LG 8. The L01 is tiled into the LG 1. Both the L02 and the L03 are tiled into the LG 2. Both the L04 and the L05 are tiled into the LG 3. All the L06, the L07, the L08 and the L09 are tiled into the LG 4. Both the L10 and the L11 are tiled into the LG 5. The L12 is tiled into the LG 6, the L13 is tiled into the LG 7 and the L14 is tiled into the LG 8.

It is understood that the processing performance of the processor can be different when the neural network is compiled according to different tiling modes. At present, for the same neural network, the compiler is usually needed to compile each tiling mode of the same neural network to obtain a processor corresponding to each tiling mode by deployment, in order to find a processor with the best processing performance. And then, measuring these processors to select a processor with the best processing performance. Such compilation mode one by one is taken a long time, resulting in very low compilation efficiency.

Therefore, the method for calculating the runtime of the neural network on the processor according to the present disclosure is provided that a time value of the processor corresponding to each tiling mode can be estimated without compiling the neural network. A tiling mode with a part of relatively smaller time value or with a time value smaller than a time cost threshold can be selected from a large number of tiling modes for compiling and deploying to obtain a corresponding processor, based on the time value of each processor. Then the processor is measured to determine the tiling mode used by the processor with the optimal processing performance, rather than needing to compile each tiling mode one by one. Thus, the compilation efficiency can be greatly improved.

For example, the compiler is configured to first determine that a plurality of tiling modes is included in a neural network A, taking a tiling mode B and a tiling mode C as an example. If the compiler compiles the neural network according to the tiling mode B, obtaining a processor A1 that has been deployed, while, if the compiler compiles the neural network according to the tiling mode C, obtaining a processor A2 that has been deployed. Although the processor A1 and the processor A2 are configured to respectively perform the neural network A to implement functions of the neural network A, their processing performances can be different. Generally, the faster a processing speed of a processor, the better processing performance of the processor is. In the present disclosure, the compiler is configured to first estimate time values of the processor A1 and the processor A2 based on flow directions of data streams, and then pre-judge the processing performance of the processor A1 and the processor A2 according to the time values. For example, a time cost threshold can be set. If an estimated time value of the processor A1 is greater than the time cost threshold, it indicates that the neural network is compiled according to the tiling mode B and the processing performance of the deployed processor A1 can be poor. The tiling mode B can be excluded by the compiler, so that the compiler is to compile the neural network without according to the tiling mode B. If an estimated time value of the processor A2 is less than the time cost threshold, it indicates that the neural network is compiled according to the tiling mode C and the processing performance of the deployed processor A2 can be better. In this way, the compiler can compile the neural network according to the tiling mode C, to deploy the processor A2, and perform further measurement on the processor A2 to determine actual processing performance of the processor A2.

That is to say, the method for calculating the runtime of the neural network on the processor of the present disclosure can be used for selecting a tiling mode with a part of relatively smaller time value or with a time value smaller than the time cost threshold from a large number of tiling modes, for compiling, and deploying to obtain a corresponding processor. Then the processing performance of each processor is measured to determine the tiling mode used by the processor with the best processing performance, rather than needing to compile for each tiling mode one by one. Thus, the compilation efficiency can be greatly improved.

The method for calculating the runtime of the neural network on the processor of the present disclosure is configured to estimate the time cost based on the flow directions of the data streams. So, for the six data streams of the processor, six time information are respectively included in the present disclosure: first time information, second time information, third time information, fourth time information, fifth time information and sixth time information.

Furthermore, the first time information is configured to indicate a time that the first DMA unit transmits the input data of the network layer from the external memory to the on-chip memory. That is, the time used by the processor to perform the data stream 1 in a course of performing calculation on a certain network layer.

The second time information is configured to indicate a time that the second DMA unit transmits parameters of the network layer from the external memory to the on-chip memory. That is, the time used by the processor to perform the data stream 2 in a course of performing calculation on the certain network layer.

The third time information configured to indicate a time that the third DMA unit transmits the input data of the network layer from the on-chip memory to the cache of the PE. That is, the time used by the processor to perform the data stream 3 in a course of performing calculation on the certain network layer.

The fourth time information is configured to indicate a time that the fourth DMA unit transmits the parameters of the network layer from the on-chip memory to the cache of the PE. That is, the time used by the processor to perform the data stream 4 in a course of performing calculation on the certain network layer.

The fifth time information is configured to indicate a time that the fifth DMA unit transmits the output data of the network layer from the cache of the PE to the on-chip memory. That is, the time used by the processor to perform the data stream 5 in a course of performing calculation on the certain network layer.

The sixth time information is configured to indicate a time that the sixth DMA unit transmits the output data of the network layer from the on-chip memory to the external memory. That is, the time used by the processor to perform the data stream 5 in a course of performing calculation on the certain network layer.

It is worth saying that the time information can be same or different for different network layers, which is depending on a size of input data quantity or output data quantity of the different network layers. For the first time information, if data quantity of the input data of the network layer A is greater than that of the network layer B, the time used by the processor to perform the data stream 1 in a course of performing calculation on a network layer a is greater than the time used by the processor to perform the data stream 1 in a course of performing calculation on a network layer b. That is to way, the first time information corresponding to the network layer a is greater than the first time information corresponding to the network layer b.

The technical solution of the present disclosure can be described in detail below with specific examples. The following several specific embodiments can be combined, and details of the same or similar concepts or processes can't be repeated in some embodiments.

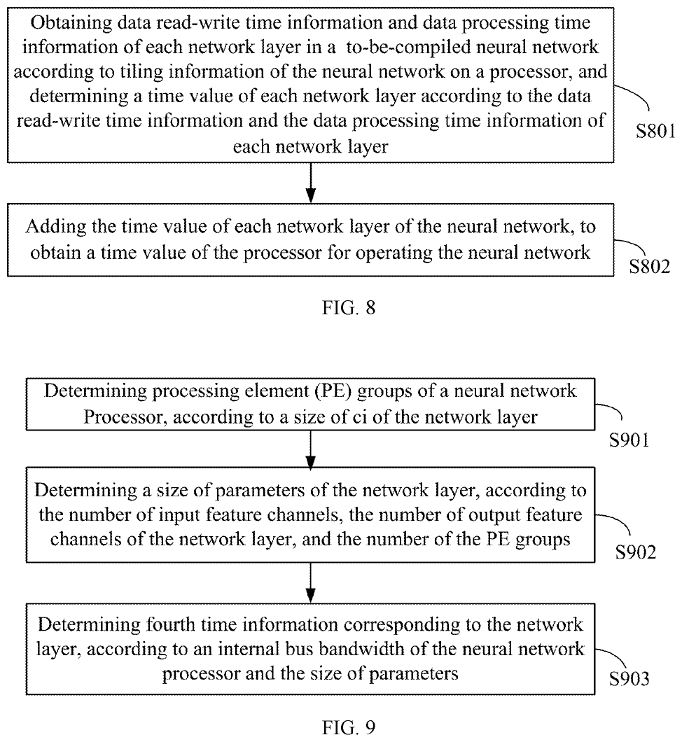

Referring to FIG. 8, a flowchart of the method for calculating the runtime of the neural network on the processor in accordance with an embodiment of the present disclosure is provided and include the following steps:

step S801, obtaining data read-write time information and data processing time information of each network layer in a to-be-compiled neural network, according to tiling information of the neural network on a processor, and determining a time value of each network layer according to the data read-write time information and the data processing time information of each network layer.

Step S802, adding the time value of each network layer in the neural network, to obtain a time value of the processor for operating the neural network for operating the neural network.

Because the neural network is composed of network layers layer by layer, and the processor is configured to perform a whole neural network calculation by performing the calculation on each network layer one by one. Therefore, in an embodiment of the present disclosure, the compiler can first estimate a time value that the processor performs the calculation on each network layer when estimating the time cost of the processor. And then, the time values of the network layers are added together to obtain the time value required by the processor to perform the whole neural network calculation.

Furthermore, the tiling information is configured to indicate that a plurality of network layers in the neural network are divided into M LGs, M is an integer more than and equal to one, and each LG group includes at least one network layer. Different tiling modes have different tiling information. The compiler is configured to determine a position of each network layer in the neural network within its own LG based on the tiling information.

For example, for the neural network as shown in FIG. 4, the tiling mode is used as shown in FIG. 7. Then, the compiler can determine that fourteen network layers in the neural network are divided into M=5 LGs, according to the tiling information of the tiling mode shown in FIG. 7. The LG 1 includes one layer of network layer: L01. The LG 2 includes four layers of network layers, which are L02, L03, L10 and L11 in turn from a first network layer to a fourth layer. The LG 3 includes two layers of network layers that a first network layer is L04, and a second layer is L05. The LG 4 includes four layers of network layers, which are L06, L07, L08 and L09 in turn from the first network layer to the fourth layer. The LG 5 includes three layers of network layers, which are L12, L13 and L14 in turn from the first network layer to a third layer.

After the compiler determines the position of each network layer within its own LG according to the tiling information, the data read-write time information of the network layer can be determined by the compiler according to the position of the network layer within its own LG. In an embodiment of the present disclosure, the data read-write time information is referred to an estimation time that a DMA unit of the processor moves data that the processor is performing the calculation on the network layer.

For any one of the M network layer groups, if the network layer group includes N network layers (N is an integer greater than and equal to two), the data read-write time information of the first network layer of the N network layers includes first time information, second time information, third time information, fourth time information and fifth time information, corresponding to the first network layer.

For example, for the first network layer L02 in the LG 2, since input (including input data and parameters) of the L02 is stored in the external memory, if the processor is to calculate the input data and the parameters of the L02, the data streams 1-4 are needed to be performed to transmit the input data and the parameters of the L02 to the IBUF and the WBUF of the PE, so that the PE can calculate output data based on the input data and the parameters of the L02. The output data of the L02 is then transmitted to the DW for storage by performing the data stream 5. Since the output data of the L02 can be directly taken as input data of the second layer L03 in the LG 2, so that the data stream 6 isn't needed to be performed by the processor and the output data can continue to be stored in the DW as the input data of a next layer. In other words, if the processor is to complete processing the L02, the data streams 1-5 are needed to be performed for moving the data thereof. Then, the data read-write time information of the L02 includes a time that the processor performs the data streams 1-5 during processing the L02. That is, the data read-write time information of the L02 includes first time information, second time information, third time information, fourth time information and fifth time information, corresponding to the L02.

For an i-th network layer (i is an integer greater than one and less than N) in the N network layers, if input data of the i-th network layer is output data of an (i−1)-th layer and does not include output data of other network layers (network layers not in the same LG as the i-th network layer), the data read-write time information of the i-th network layer includes third time information, fourth time information and fifth time information, corresponding to the i-th network layer.

For example, for the second layer L03 in the LG 2, since input (including input data and parameters) of the L03 is stored in the DM, if the processor is to calculate input data and parameters of the L03, the data streams 3-4 are needed to be performed to transmit the input data and the parameters of the L03 to the IBUF and the WBUF of the PE, so that the PE can calculate output data based on the input data and the parameters of the L03. The output data of the L03 is then transmitted to the DW for storage by performing the data stream 5. Since the output data of the L03 can be directly taken as input data of the third layer L10 in the LG 2, so that the data stream 6 isn't needed to be performed by the processor and output data of the L10 can continue to be stored in the DW as input data of a next layer. In other words, if the processor is to completely process the L03, the data streams 3-5 are needed to be performed for moving data thereof. Then, the data read-write time information of the L03 includes a time that the processor is to perform the data streams 1-5 during processing the L03. That is, the data read-write time information of the L03 includes third time information, fourth time information and fifth time information, corresponding to the L03.

For the i-th network layer of the N network layers, if the input data of the i-th network layer includes output data of other network layers that do not belong to the same LG as the i-th network layer, the data read-write time information of the i-th network layer includes first time information, third time information, fourth time information and fifth time information, corresponding to the i-th network layer.

For example, for the third layer L10 in the LG 2, the input data of the L10 includes the output data of the L03 in the LG 2, and output data of the L09 in the LG 4. Since the output data of the L09 taken as the output data of the LG 4 is stored in the external memory, if the processor is to calculate the input data and the parameters of the L10, the output data of the L09 is first transmitted to the DW by performing the data stream 1. The data stream 3 is then needed to be performed to transmit the input data (including the output data of the L09 and the L03) of the L10 to the IBUF of the PE. The data stream 4 is performed to transmit the parameters of the L10 to the WBUF of the PE, so that the PE can calculate output data based on the input data and the parameters of the L10. Finally, the data stream 5 is performed to transmit the output data of the L10 to the DW for storage.

Since the output data of the L10 can be directly taken as input data of the fourth layer L11 in the LG 2, so that the data stream 6 isn't needed to be performed by the processor and the output data can continue to be stored in the DW as input data of a next layer. In other words, if the processor is to completely process the L10, the data streams 1, 3-5 are needed to be performed for moving the data thereof. Then, the data read-write time information of the L10 includes a time that the processor is configured to perform the data streams 1, 3-5 during processing the L10. That is, the data read-write time information of the L10 includes first time information, second time information, third time information, fourth time information and fifth time information, corresponding to the L10.

An N-th network layer of the N network layers includes third time information, fourth time information, fifth time information and sixth time information, corresponding to the N-th network layer.

For the fourth layer L11 in the LG 2, since input (including input data and parameters) of the L11 is stored in the DM. If the processor is to calculate the input data and the parameters of the L11, the data streams 3-4 are needed to be performed to transmit the input data and the parameters of the L11 to the IBUF and the WBUF of the PE, so that the PE can calculate output data based on the input data and the parameters of the L11. The output data of the L11 is then transmitted to the DW for storage by performing the data stream 5. Since the output data of the L11 is the input data of the LG 2, it indicates that the LG 2 has been calculated. So, the data stream 6 is needed to be performed by the processor to transmit the output data of the L11 to the external memory for storage, so that there is enough space in the DM for the processor to process other LGs. In other words, if the processor is to completely process the L11, the data streams 3-6 are needed to be performed for moving the data thereof. Then, the data read-write time information of the L11 includes a time that the processor is configured to perform the data streams 3-6 during processing the L11. That is, the data read-write time information of the L11 includes third time information, fourth time information, fifth time information and sixth time information, corresponding to the L11.

Optionally, for any one of the M network layer groups, if the network layer group includes a network layer, the data read-write time information of the network layer includes first time information, second time information, third time information, fourth time information, fifth time information and sixth time information, corresponding to the network layer.

For example, the LG 1 only includes a network layer L01, that is, input and output of the L01 are input and output of the LG 1. If the processor is to process the L01, the data streams 1-4 are needed to be performed to transmit the input data and the parameters of the L01 from the external memory to the IBUF and the WBUF of the PE, so that the PE can calculate output data based on the input data and the parameters of the L01. The output data of the L01 is then transmitted to the external memory for storage by performing the data streams 5-6. In other words, if the processor is to completely process the L01, the data streams 1-6 are needed to be performed for moving the data thereof. Then, the data read-write time information of the L01 includes a time that the processor is configured to perform the data streams 1-6 during processing the L01. That is, the data read-write time information of the L01 includes first time information, second time information, third time information, fourth time information, fifth time information and sixth time information, corresponding to the L01.

In an embodiment of the present disclosure, the first time information, the second time information, the third time information, the fourth time information, the fifth time information, and the sixth time information can be calculated according to data quantity transmitted in corresponding data streams.

For example, when the first time information is calculated, the input data of the network layer can be configured to directly determine the data quantity of the input data according to the number of feature channels, widths and heights of the input data, so, the compiler can be configured to calculate the first time information according to the data quantity of the input data and a preset first transmission time.

The first transmission time is referred to a time required for transmitting each data quantity unit (for example, 1024 bits) by an external bus of the processor.

Furthermore, the first transmission time can be obtained in an ideal situation by measuring a time that an instruction is sent by the processor to the external memory until a corresponding response is received. The ideal situation is referred to a state that an external bus between the processor and the external memory only transmits the instruction therebetween.

The compiler can be configured to divide the data quantity of the input data by the unit data quantity, and then multiply by the first transmission time to obtain the first time information.

Similarly, because the data stream 2 and the data stream 6 are configured to perform data transmission between the processor and the external memory, then, the compiler can also be configured to calculate the second time information and the sixth time information based on data quantity of the parameters and data quantity of the output data by using the first transmission time required by the unit data quantity.

In an example, the compiler can also be configured to calculate the third time information according to the data quantity of the input data and a preset second transmission time.

The second transmission time is referred to a time required for transmitting each data quantity unit (for example, 1024 bits) by an internal bus of the processor. The second transmission time can be obtained in the ideal situation by measuring a time that an instruction is sent by the DM through the internal bus of the processor to the IBUF until a corresponding response is received. The compiler can be configured to divide the data quantity of the input data by the unit data quantity, and then multiply by the second transmission time to obtain the third time information.

Similarly, because the data stream 3 and the data stream 5 are configured to perform the data transmission through the internal bus of the processor, then, the compiler can also be configured to calculate the fifth time information by using the second transmission time required by the unit data quantity. That is, the compiler can be configured to divide the data quantity of the output data by the unit data quantity, and then multiply by the second transmission time required by the unit data quantity to obtain the fifth time information.

In an example, referring to FIG. 9, obtaining the fourth time information corresponding to the network layer can include:

step S901, determining PE groups of the processor according to a size of ci of the network layer, each PE group including at least one PE.

For example, a width of the ci is 100p, and the processor includes 32 PEs, each PE includes ten MAC modules (i.e., each PE can calculate 10p at a time). Then, the processor needs 10 PEs for calculating one co. Therefore, every ten PEs of the 32 PEs can be divided into a group, with a total of three groups and remaining two PEs.

Step S902, determining a size of parameters required to be transmitted by the PE group according to the number of input feature channels and the number of output feature channels of the network layer, and the number of the PE groups.

For example, it is assumed that the number of input feature channels (that is, the number of ci) is ten, and the number of output feature channels (that is, the number of co) is six, since the 32 PEs in the processor are divided into three groups, the three PE groups can be simultaneously calculated to obtain three cos. Therefore, the six cos need to be completely calculated by two rounds. That is to say, each PE group needs to perform two rounds of calculation on ten cis by using the parameters, to obtain two cos. Therefore, for each PE group, there are 10×2 pairs of cis and cos. Each pair of cis and cos is needed a weight in the calculation. That is, twenty weights are required for each PE group.

Step S903, determining the fourth time information corresponding to the network layer according to an internal bus bandwidth of the processor and the size of parameters required to be transmitted by one of the PE groups.

In the example, the data quantity of the parameters required to be transmitted by the PE group can be obtained according to the size of parameters required to be transmitted by the PE group. For example, one PE group needs to transmit twenty weights that each is a 3×3 convolution kernel. The data quantity of the parameter required to be transmitted by the PE group is divided by the internal bus bandwidth (referring to a bus bandwidth between the WM and the IBUF) of the processor, so that time information that the WM transmits the parameters to the PE group can be obtained.

It should be noted that, the WM transmits the parameters to each PE group in a manner of alternate distribution. Firstly, respectively sending the weights required by the first round of calculation to each PE group in turn. The WM is configured to send the weights required by the first round to a first PE group, then send the weights required by the first round to a second PE group, then send the weights required by the first round to a third PE group, and so on until the weights required by the first round have been sent to all PE groups. And then, continuously and sequentially sending the weights required by the second round of calculation to each PE group. In order to ensure a better processing performance of the processor, the WM usually sends a small number (for example, one) of weights to each PE group for each round of calculation, which is sufficient to ensure that the PE group can be performed the convolution calculation. Since the number of weights is small and resources of the internal bus bandwidth are sufficient, it can be considered that sending the weights to each of the PE groups are almost parallel. Accordingly, it can be determined that the time information that the WM transmits the parameters to the PE group is the fourth time information corresponding to the network layer.

It can be understood that, for any network layer of the neural network, the processor not only is needed to perform relevant data stream operations, but also needed to perform data processing operations during performing the network layer calculation. For example, after the input data and the parameters of the network layer are transmitted to the cache of the PE, the PE is needed to calculate the output data according to the input data and the parameters, so that such data processing process is also entailed the time cost. The compiler needs to obtain the data processing time information corresponding to the network layer when calculating a time value of the network layer.

Furthermore, the data processing time information is referred to a time that the PE of the processor is configured to calculate the output data according to the input data and the parameters of the network layer when the processor performs the calculation on the network layer.

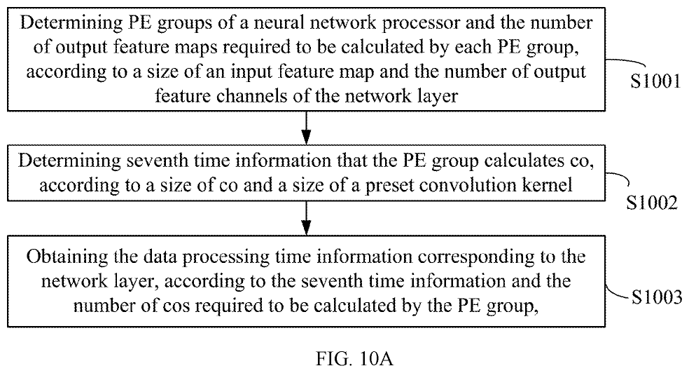

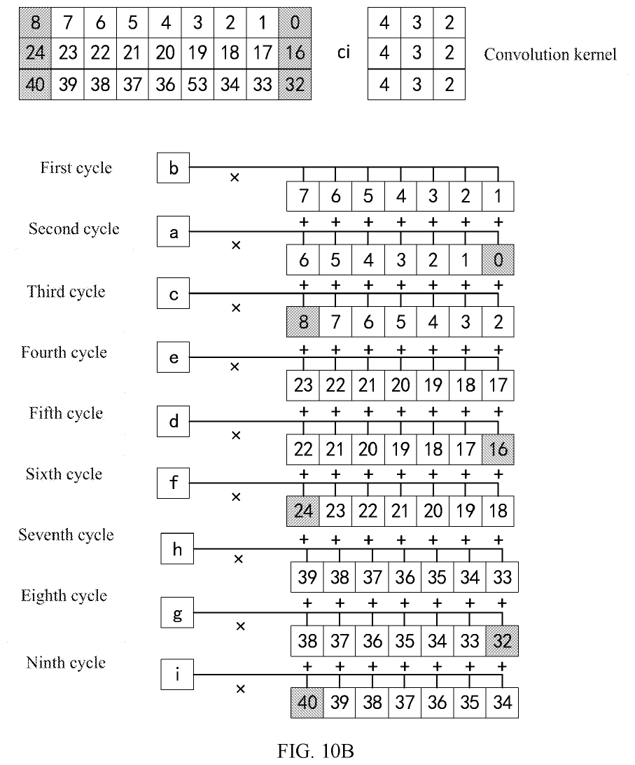

In an embodiment of the present disclosure, referring to FIG. 10A, for any network layer of the neural network, obtaining the data processing time information corresponding to the network layer, can include:

step S1001, determining PE groups of the processor and the number of output feature maps required to be calculated by each PE group, according to the size of the input feature map and the number of output feature channels of the network layer, each PE group including at least one PE.

For example, it is assumed that the number of feature channels (i.e., the number of ci) of the input data of the network layer is 32, the width of the ci is 112p, and the height of the ci is 60p. The processor includes 32 PEs and each PE includes seven MAC modules (that is, each PE can calculate 7p at a time).

Then, according to the width 112p of the ci, 16 PEs are needed by the processor to calculate one co. So, every 16 PEs of the 32 PEs can be divided into a group, with a total of two groups.

According to the number of co 100, it can be determined that the two PE groups need to be calculated by 50 rounds, that is to say, 50 cos are needed to be calculated by each PE group.

Step S1002, determining seventh time information required by the PE group to calculate one co according to a size of the co and a size of a preset convolution kernel.

The number of weights included in the convolution kernel can be determined according to the size of the convolution kernel. For example, a 3×3 convolution kernel includes 9 weights, a 1×1 convolution kernel includes one weight, and a 5×5 convolution kernel includes 25 weights.

Then, obtaining the number of clock cycles that the PE group calculates one co so as to obtain the seventh time information, according to a product of the number of weights and the height of the co.

Furthermore, a duration of one cycle can be determined according to dominant frequency of the processor. For example, if the dominant frequency of the neural network is 700 MHz, the duration of the cycle is one 700 M-th second.

It can be understood that each PE of the PE group is calculated in parallel when the PE group calculates the co, and therefore, a convolution calculation time of one PE is calculated, that is, a time required that one PE group is to calculate the co can be known.

If each PE includes seven MAC modules, each PE is configured to calculate seven pixels for each row in the cos. If the size of the convolution kernel is 3×3, values of three rows and nine columns of pixels in the ci (i.e. 27 pixels in the ci) are needed to be used by the PE when calculating the seven pixels. Since the convolution kernel includes nine weights, nine cycles are needed to complete the calculation.

For example, when the PE1 is configured to calculate the seven pixels in a first row of cos, data of the ci needed to be used is as shown in FIG. 10B. In a first cycle, the shift/mux module is configured to send data of seven continuous pixels (namely P1-P7) in the first row of cis from the IBUF to the seven MAC modules, respectively, and the MAC module is configured to multiply the data of P1-P7 by a weight b of a first row in the convolution kernel, respectively.

In a second cycle, the shift/mux module is configured to shift the data of the P1-P7 to the left, that is, data of a pixel P0 is received from the PE0 and data of the pixel P7 is sent to the PE2, and then data of the pixels P0-P6 is sent to the seven MAC modules, respectively, and the MAC module is configured to multiply the data of the pixels PO-P6 by a weight a of the first row in the convolution kernel, respectively, and then add to a calculation result of the first cycle.

In a third cycle, the shift/mux module is configured to shift the data of the pixels P1-P7 to the left, that is, the data of the pixel P1 is sent to the PE0 and data of a pixel P8 is received from the PE2, and then data of the pixels P2-P8 is sent to the seven MAC modules, respectively, and the MAC module is configured to multiply the data of the pixels P2-P8 by a weight c of the first row in the convolution kernel, respectively, and then add to a calculation result of the second cycle.

In a fourth cycle, the shift/mux module is configured to send data of seven continuous pixels in a second row of cis (i.e., P17-P23) from the IBUF to the seven MAC modules, respectively, and the MAC module is configured to multiply data of the pixels P17-P23 by a weight e of the second row in the convolution kernel, respectively, and then add to a calculation result of the third cycle.

In a fifth cycle, the shift/mux module is configured to shift the data of the pixels P17-P23 to the left, that is, data of a pixel P16 is received from the PE0 and the data of the pixel P23 is sent to the PE2, and then data of the pixels P16-P22 is sent to the seven MAC modules, respectively, and the MAC module is configured to multiply the data of the pixels P16-P22 by a weight d of the second row in the convolution kernel, respectively, and then add to a calculation result of the fourth cycle.

In a sixth cycle, the shift/mux module is configured to shift the data of the pixels P17-P23 to the left, that is, the data of the pixel P17 is sent to the PE0 and data of a pixel P24 is received from the PE2, and then data of the pixels P18-P24 is sent to the seven MAC modules, respectively, and the MAC module is configured to multiply the data of the pixels P18-P24 by a weight f of the second row in the convolution kernel, respectively, and then add to a calculation result of the fifth cycle. At this time, data calculation between weights of the second row and the pixels of the second row of cis is completed.

In a seventh cycle, the shift/mux module is configured to send the data of the seven continuous pixels in the second row of cis (i.e., P33-P39) from the IBUF to the seven MAC modules, respectively, and the MAC module is configured to multiply data of the pixels P33-P39 by a weight h of a third row in the convolution kernel, respectively, and then add to a calculation result of the sixth cycle.

In an eighth cycle, the shift/mux module is configured to shift the data of the pixles P33-P39 to the left, that is, data of a pixel P32 is received from the PE0 and the data of the pixel P39 is sent to the PE2, and then data of the pixels P32-P38 is sent to the seven MAC modules, respectively, and the MAC module is configured to multiply the data of the pixels P32-P38 by a weight g of the third row in the convolution kernel, respectively, and then add to a calculation result of the seventh cycle.

In a ninth cycle, the shift/mux module is configured to shift the data of the pixels P33-P39 to the left, that is, the data of the pixel P3 is sent to the PE0 and data of a pixel P40 is received from the PE2, and then data of the pixels P34-P40 is sent to the seven MAC modules, respectively, and the MAC module is configured to multiply the data of the pixels P34-P40 by a weight i of the third row in the convolution kernel, respectively, and then add to a calculation result of the eighth cycle. At this time, data calculation between the weights of the second row and the pixels of the second row of cis is completed. After the ninth cycle is finished, obtained value is a numerical value of the seven pixels calculated by the PE1 in the first row of cos.

In summary, since each PE in the PE group is calculated in parallel, in the case that the size of the convolution kernel is 3×3, nine cycles are needed by the PE group to completely perform the convolution calculation on a row of pixels in the co.

The height of the co is 60p (that is, including 60 rows of pixels), therefore, 60×9=540 cycles are needed by the PE group to completely perform the convolution calculation on one co.

S1003, obtaining the data processing time information corresponding to the network layer, according to the seventh time information and the number of cos required to be calculated by the PE group.

For example, Each PE group needs to calculate 50 cos, and ten microseconds are needed to calculate one co, so that 500 microseconds are needed by the PE group to completely perform the calculation on 50 cos. Since each PE group in the processor performs the calculation in parallel, one PE group completes the calculation of 50 cos, it indicates that the other PE groups also complete the calculation of 50 cos, i.e. the data processing of the network layer is completed. Therefore, the data processing time information corresponding to the network layer can be obtained by obtaining one PE group to complete the calculation of 50 cos.

The time value of the network layer can be calculated according to the data processing time information and the data read-write time information, after obtaining the data processing time information and the data read-write time information of the network layer.

When the processor performs the neural network calculation, if each FU is performed in an asynchronous manner, that is, the EIDMA, the EWDMA, the IDMA, the WDMA, the ODMA, the n PEs and the EODMA are performed corresponding operations in the asynchronous manner. The compiler can be configured to superimpose the data processing time information and the data read-write time information of the network layer to obtain the time value of the network layer.

When the processor performs the neural network calculation, if some of the FUs are performed in a synchronous manner, while the others of the FUs are performed in an asynchronous manner. For example, first, the EIDMA and the EWDMA are started to perform relevant operations at the same time, second, the IDMA and the WDMA are started to perform relevant operations at the same time, and then the n PEs are started to perform relevant operations. Finally, the ODMA and the EODMA are started to perform relevant operations in turn.

In the example, respective network layers of the LG 1 and the LG 2 shown in FIG. 7 are taken as an example. During estimating a time value of the L01, the compiler can be configured to add a maximum value of the first time information and the second time information, a maximum value of the third time information and the fourth time information, the data processing time information, the fifth time information and the sixth time information, corresponding to the L01, to obtain the time value of the L01.

During estimating a time value of the L02, the compiler can be configured to add a maximum value of the first time information and the second time information, a maximum value of the third time information and the fourth time information, the data processing time information and the fifth time information, corresponding to the L02, to obtain the time value of the L02.

During estimating a time value of the L03, the compiler can be configured to add a maximum value of the third time information and the fourth time information, the data processing time information and the fifth time information, corresponding to the L03, to obtain the time value of the L03.

During estimating a time value of the L10, the compiler can be configured to add a maximum value of the first time information, the third time information and the fourth time information, the data processing time information and the fifth time information, corresponding to the L10, to obtain the time value of the L10.

During estimating a time value of the L11, the compiler can be configured to add a maximum value of the third time information and the fourth time information, the data processing time information, the fifth time information and the sixth time information, corresponding to the L11, to obtain the time value of the L11.

Optionally, in order to further improve the processing performance of the processor, a small granularity synchronization mode according to an embodiment of the present disclosure is provided to implement synchronization of each FU when the processor performs the neural network calculation.

An LG including N (N greater than and equal to two) network layers (for example, the LG 2 in the neural network shown in FIG. 7) is taken as an example, when the processor performs the calculation on the LG according to a minimal granularity synchronous manner, the synchronization mode between the FUs is carried out for illustrative sensitization.

For a first network layer (such as the L02 of the LG 2) of the LG, if the processor performs the calculation on the i-th network layer according to the minimal granularity synchronous manner, operations of each FU are described below:

starting the EIDMA to transmit input data of the first network layer from the external memory to the DM.

Both the EIDMA and the IDMA are synchronized based on the small granularity synchronization manner. That is, after the EIDMA is started and k cis are transmitted by the EIDMA to the DM (k is an integer more than and equal to one), starting the IDMA to transmit by the broadcasting mode, the ci stored in the DM to the IBUF of each PE that needs to be used. At the same time, the EIDMA continues to transmit the remaining cis in the external memory to the DM.

In the process, K (K is an integer more than and equal to one) handshakes are established between the EIDMA and the DM, and the k cis are transmitted in each handshake. Wherein, k is preset synchronous granularity between the EIDMA and the IDMA, and K is equal to the number of input feature channels divided by k. That is to say, after a first batch of cis (i.e. k cis) is completely transmitted, the IDMA can be started to perform a transmission operation on the ci).

The ci is moved by the IDMA from the DM to the IBUF, and after the IBUF is full, the IDMA stops to move the ci. And then, if free buffer spaces exist in the IBUF, the IDMA continuously transmits the ci to the IBUF.

Starting the EWDMA to transmit parameters of the first network layer from the external memory to the WM.

Both the EWDMA and the WDMA are synchronized based on the small granularity synchronization manner. That is, after the EWDMA is started and j rows of weights of the parameters are transmitted to the WM, starting the WDMA, and transmitting corresponding weights stored in the WM to the WBUF of a corresponding PE. At the same time, the EWDMA continues to transmit the remaining weights in the external memory to the WM.

In the process, J (J is an integer more than and equal to one) handshakes are established between the EWDMA and the WM, and the j rows of weights are transmitted in each handshake. Wherein, j is preset synchronous granularity between the EWDMA and the WDMA, and J is equal to a total number of rows of the weights divided by j. That is to say, after a first batch of weights (i.e. j rows of weights) is completely transmitted, the WDMA can be started to perform the transmission operation on the weights.

The weights are moved by the WDMA from the WM to the WBUF of a corresponding PE, and after the WBUF is full, the WDMA stops to move the weights. And then, if free buffer spaces exist in the WBUF, the WDMA continuously transmits the weights to the WBUF.

After data is cached in both the IBUF and the WBUF, the PE is configured to start to calculate the ci by using the weights, so as to obtain the co that is cached in the OBUF. The PE stops the calculation once the ci in the IBUF is exhausted or the weights in the WBUF are used up. And then, it is waited that the IDMA is to continue transmitting the ci to the IBUF, or the WDMA is to continue transmitting the weights to the WBUF.

Each round of calculation on the co is performed, The ODMA is configured to start to transmit the co cached in the OBUF to the DM.

For the first network layer, parallel relationships between the FUs are shown as follows:

(1) the EIDMA and the EWDMA are in parallel.

(2) the IDMA and the WDMA are in parallel.

(3) the PEs are parallel to each other.

(4) the first batch of cis transmitted by the EIDMA and the ci transmitted by the IDMA are serial.

(5) the first batch of weights transmitted by the EWDMA and the weights transmitted by the WDMA are serial.

(6) the ODMA and the IDMA are serial, and the ODMA and the WDMA are serial.

In an embodiment of the present disclosure, the so-called in parallel is meant that two FUs are configured to perform relevant operations simultaneously, and the so-called serial is meant that the two FUs are configured to perform relevant operations in sequence.

In the example, if the processor is performed the calculation on the first network layer, the data read time information of the first network layer includes first time information, second time information, third time information, fourth time information and fifth time information. Furthermore, a time period is completely overlapped in the fourth time information (i.e., a time that the WDMA transmits the weights from the WM to the WBUF) from a second handshake setup between the EWDMA and the WM until all weights are transmitted to the WM. A time period is completely overlapped in the third time information (i.e., a time that the IDMA transmits the weights from the DM to the IBUF) from a second handshake setup between the EIDMA and the DM until all cis are transmitted to the DM. The third time information, the fourth time information and the data processing time information, corresponding to the first network layer, are affected to each other and are overlapped with each other.

Thus, in the example, determining a time value of the first network layer includes:

step S11, determining a first maximum value of the third time information, the fourth time information and the data processing time information, corresponding to the first network layer.

Step S12, determining a second maximum value of one K-th of the first time information and one J-th of the second time information, corresponding to the first network layer.

It is understandable that the first time information can be divided into K segments and k cis are transmitted by each of the K segments, according to the number of handshakes between the EIDMA and the DM. The second time information can be divided into J segments, and j rows of weights are transmitted by each of the J segments, according to the number of the handshakes between the EWDMA and the WM. Since the EIDMA and the EWDMA are in parallel, the first batch of cis transmitted by the EIDMA and the ci transmitted by the DMA are serial, and the first batch of weights transmitted by the EWDMA and the weights transmitted by the WDMA are serial. In this way, a maximum value of a time of the first batch of weights transmitted by the EWDMA and a time of the first batch of cis transmitted by the EIDMA are needed to be superimposed to a time cost of the first network layer. The time of the first batch of weights transmitted by the EWDMA is one J-th of the second time information, and the time of the first batch of cis transmitted by the EIDMA is one K-th of the first time information.

Step S13, adding the first maximum value, the second maximum value and the fifth time information, corresponding to the first network layer, to obtain the time value of the first network layer.

For an i-th network layer of the LG, if the input data of the i-th network layer is output data of an (i−1)-th network layer and does not include output data of other network layers (network layers are not in the same LG as the i-th network layer), for example, the L03 in the LG 2, if the processor is configured to perform the calculation on the i-th network layer according to the minimum granularity synchronous manner, operations of each FU are shown as follows:

the IDMA starts to transmit the ci of the i-th network layer stored in the DM to the IBUF of each PE by the broadcasting mode, after the IBUF is full, the IDMA stops to move the ci. And then, if the free buffer spaces exist in the IBUF, the IDMA continuously transmits the ci to the IBUF.

The WDMA starts to transmit the weights stored in the WM to the WBUF of the corresponding PE, after the WBUF is full, the WDMA stops to move the weights. And then, if the free buffer spaces exist in the WBUF, the WDMA continuously transmits the weights to the WBUF.

After the data is cached in both the IBUF and the WBUF, the PE is configured to start to calculate the ci of the i-th network layer by using the weights of the i-th network layer, so as to obtain the co of the i-th network layer that is cached in the OBUF. The PE stops calculation once the ci in the IBUF is exhausted or the weights in the WBUF are used up, so that it is waited that the IDMA is to continue transmitting the ci to the IBUF, or the WDMA is to continue transmitting the weights to the WBUF.

Each round of calculation on the co is performed, The ODMA is configured to start to transmit the co cached in the OBUF to the DM.

For the first network layer, parallel relationships between the FUs are shown as follows:

(1) the EIDMA and the EWDMA are in parallel.

(2) the PEs are parallel to each other.

(3) the ODMA and the IDMA are serial, and the ODMA and the WDMA are serial.

In the example, if the processor performs the calculation on the i-th network layer, the data read time information of the i-th network layer includes third time information, fourth time information, and fifth time information. Determining a time value of the i-th network layer includes:

obtaining the time value of the i-th network layer by adding a maximum value of the third time information, the fourth time information and the data processing time information, and the fifth time information, corresponding to the i-th network layer.

For the i-th network layer of the LG, if the input data of the i-th network layer includes the output data of other network layers that do not belong to the LG, for example, the L10 in the LG 2, if the processor is configured to perform the calculation on the i-th network layer according to the minimum granularity synchronous manner, operations of each FU are shown as follows:

the IDMA starts to transmit the input data of the i-th network layer from the external memory to the DM. For example, for the L10, some of the input data of the L10 is the output data of the L03 stored in the DM, some of the input data of the L10 is the output data of the L09 stored in the external memory. So, it is necessary to start the EIDMA to transmit the output data of the L09 from the external memory to the DM.

After the EIDMA is started and the first batch of cis (namely k cis) are transmitted by the EIDMA to the DM, starting the IDMA to transmit by the broadcasting mode, the ci of the i-th network layer stored in the DM to the IBUF of each PE that needs to be used. After the IBUF is full, the IDMA stops to move the ci. And then, if the free buffer spaces exist in the IBUF, the IDMA continuously transmits the ci to the IBUF. At the same time, the EIDMA continues to transmit the remaining cis in the external memory to the DM.

The WDMA starts to transmit the weights stored in the WM to the WBUF of the corresponding PE, after the WBUF is full, the WDMA stops to move the weights. And then, if the free buffer spaces exist in the WBUF, the WDMA continuously transmits the weights to the WBUF.

After the data is cached in both the IBUF and the WBUF, the PE is configured to start to calculate the ci of the i-th network layer by using the weights of the i-th network layer, so as to obtain the co of the i-th network layer that is cached in the OBUF. The PE stops calculation once the ci in the IBUF is exhausted or the weights in the WBUF are used up, so that it is waited that the IDMA is to continue transmitting the ci to the IBUF, or the WDMA is to continue transmitting the weights to the WBUF.

Each round of calculation on the co is performed, The ODMA is configured to start to transmit the co cached in the OBUF to the DM.

For the i-th network layer, parallel relationships between the FUs are shown as follows:

(1) the first batch of cis transmitted by the EIDMA and the ci transmitted by the IDMA are serial.

(2) the IDMA and the WDMA are in parallel.

(3) the PEs are parallel to each other.

(4) the ODMA and the IDMA are serial, and the ODMA and the WDMA are serial.

In the example, the data read time information of the i-th network layer includes first time information, third time information, fourth time information and fifth time information. If the processor performs the calculation on the i-th network layer, a time period is completely overlapped in the third time information (i.e., a time that the IDMA transmits the weights from the DM to the IBUF) from the second handshake setup between the EIDMA and the DM until all cis are transmitted to the DM.

Therefore, determining the time value of the i-th network layer includes:

obtaining the time value of the i-th network layer by adding a maximum value of the third time information, the fourth time information and the data processing time information and one K-th of the first time information and the fifth time information, corresponding to the i-th network layer.

For an N-th network layer of the LG, if the processor is configured to perform the calculation on the N-th network layer, according to the minimum granularity synchronous manner, the operations of the FUs are as follows:

the IDMA starts to transmit the ci of the N-th network layer stored in the DM to the IBUF of each PE by the broadcasting mode, after the IBUF is full, the IDMA stops to move the ci. And then, if the free buffer spaces exist in the IBUF, the IDMA continuously transmits the ci to the IBUF.

The WDMA starts to transmit the weights stored in the WM to the WBUF of the corresponding PE, after the WBUF is full, the WDMA stops to move the weights. And then, if the free buffer spaces exist in the WBUF, the WDMA continuously transmits the weights to the WBUF.

After the data is cached in both the IBUF and the WBUF, the PE is configured to start to calculate the ci of the N-th network layer by using the weights of the N-th network layer, so as to obtain the co of the N-th network layer that is cached in the OBUF. The PE stops calculation once the ci in the IBUF is exhausted or the weights in the WBUF are used up, so that it is waited that the IDMA is to continue transmitting the ci to the IBUF, or the WDMA is to continue transmitting the weights to the WBUF.

Each round of calculation on the co is performed, The ODMA is configured to start to transmit the co cached in the OBUF to the DM.

After the first round of co is transmitted from the ODMA to the DM, the EODMA is started to transmit the co of the N-th network layer stored in the DM to the external memory.

For the N-th network layer, parallel relationships between the FUs are shown as follows:

(1) the IDMA and the WDMA are in parallel.

(2) the PEs are parallel to each other.

(3) the ODMA and the IDMA are serial, and the ODMA and the WDMA are serial.

(4) the last round of co transmitted by the ODMA and the co calculated by the PE are serial.

In the example, if the processor performs the calculation on the N-th network layer, the data read time information of the N-th network layer includes third time information, fourth time information, fifth time information and sixth time information. Furthermore, a time period is completely overlapped in the data processing time information (that is, a time that the PE calculates the co according to the ci and the weights) from starting the EODMA until before the co obtained by the last round of calculation is transmitted to the external memory.

Therefore, determining a time value of the N-th network layer includes:

obtaining the time value of the N-th network layer by adding a maximum value of the third time information, the fourth time information and the data processing time information, the fifth time information and one L-th of the sixth time information, corresponding to the N-th network layer.

Wherein L represents a preset number of handshakes between the EODMA and the external memory, and L is an integer greater than and equal to one. A size of L depends on rounds of the co calculated by the PE in the N-th network layer. Since the last round of co transmitted by the ODMA and the co calculated by the PE are serial, a time that the last round of co is transmitted by the EODMA is superimposed to the time value of the N-th network layer. The time that the last round of co is transmitted by the EODMA is one L-th of the sixth time information.

For example, for an LG including one network layer (e.g., the LG 1 in the neural network shown in FIG. 7), if the processor is configured to perform the calculation on the network layer according to the minimum granularity synchronous manner, the operations of the FUs are as follows:

starting the EIDMA to transmit the input data from the external memory to the DM.

After the EIDMA is started and the first batch of cis (namely k cis) are transmitted by the EIDMA to the DM, starting the IDMA to transmit by the broadcasting mode, the ci stored in the DM to the IBUF of each PE that needs to be used. At the same time, the EIDMA continues to transmit the remaining cis in the external memory to the DM.

In the process, K handshakes are established between the EIDMA and the DM, and the k cis are transmitted in each handshake.

The ci is moved by the IDMA from the DM to the IBUF, and after the IBUF is full, the IDMA stops to move the ci. And then, if the free buffer spaces exist in the IBUF, the IDMA continuously transmits the ci to the IBUF.

Starting the EWDMA to transmit the parameters from the external memory to the WM.

After the EWDMA is started to transmit j rows of weights in the parameters to the WM, starting the WDMA to transmit the weights stored in the WM to the WBUF of the corresponding PE. At the same time, the EWDMA continues to transmit the remaining weights in the external memory to the WM.

In the process, J handshakes are established between the EWDMA and the WM, and the j rows of weights are transmitted in each handshake.

The weights are moved by the WDMA from the WM to the WBUF, and after the WBUF is full, the WDMA stops to move the weights. And then, if the free buffer spaces exist in the WBUF, the WDMA continuously transmits the weights to the WBUF.

After the data is cached in both the IBUF and the WBUF, the PE is configured to start to calculate the ci by using the weights of the network layer, so as to obtain the co that is cached in the OBUF. The PE stops calculation once the ci in the IBUF is exhausted or the weights in the WBUF are used up, so that it is waited that the IDMA is to continue transmitting the ci to the IBUF, or the WDMA is to continue transmitting the weights to the WBUF.

Each round of calculation on the co is performed, The ODMA is configured to start to transmit the co cached in the OBUF to the DM.

After the first round of co is transmitted by the ODMA to the DM, the EODMA is started to transmit the co stored in the DM to the external memory.

(1) the EIDMA and the EWDMA are in parallel.

(2) the IDMA and the WDMA are parallel.

(3) the PEs are parallel to each other.

(4) the first batch of cis transmitted by the EIDMA and the ci transmitted by the IDMA are serial.

(5) the first batch of weights transmitted by the EWDMA and the weights transmitted by the WDMA are serial.

(6) the ODMA and the IDMA are serial, and the ODMA and the WDMA are serial.

(7) the last round of co transmitted by the ODMA and the co calculated by the PE are serial.

In the example, if the processor performs the calculation on the network layer, the data read time information of the network layer includes first time information, second time information, third time information, fourth time information, fifth time information and sixth time information. Furthermore, a time period is completely overlapped in the fourth time information (i.e., a time that the WDMA transmits the weights from the WM to the WBUF) from the second handshake setup between the EWDMA and the WM until all weights are transmitted to the WM. A time period is completely overlapped in the third time information (i.e., a time that the IDMA transmits the weights from the DM to the IBUF) from the second handshake setup between the EIDMA and the DM until all cis are transmitted to the DM. A time period is completely overlapped in the data processing time information (that is, a time that the PE calculates the co according to the ci and the weights) from starting the EODMA until before the co obtained by the last round of calculation is transmitted to the external memory.

Therefore, when the one network layer is included in the LG, determining a time value of the one network layer, includes:

step S21, determining a third maximum value of the third time information, the fourth time information and the data processing time information, corresponding to the network layer.

Step S22, determining a fourth maximum value of one K-th of the first time information and one J-th of the second time information, corresponding to the network layer.

Step S23, obtaining the time value of the network layer by adding the third maximum value, the fourth maximum value, and the fifth time information and one L-th of the sixth time information, corresponding to the network layer.

Thus, it can be seen, if the neural network calculation is performed according to the small granularity synchronous mode provided by the present disclosure, the time cost of any network layer in the neural network can be greatly reduced, and the processing performance of the processor can be further improved.

In one example, if the EIDMA and the EWDMA are in parallel, the internal read-port bandwidth in the processor is needed to be shared (that is, a port bandwidth of reading data that the processor connects to the external memory). If a sum of an average bandwidth of the EIDMA for reading the input data from the external memory and an average bandwidth of the EWDMA for reading input parameters from the external memory exceeds the internal read-port bandwidth of the processor, the EIDMA and the EWDMA will compete for resources of the internal read-port bandwidth inside the processor, which will inevitably cause one of the EIDMA and the EWDMA to be in a state of waiting to read data, thus prolonging the time cost.

If the EIDMA, the EWDMA and the EODMA are in parallel, the external bus bandwidth in the processor is needed to be shared (that is, a transmission bus bandwidth between the processor and the external memory). If a sum of the average bandwidth of the EIDMA for reading the input data from the external memory, the average bandwidth of the EWDMA for reading the input parameters from the external memory, and an average bandwidth of the EWDMA for writing parameters to the external memory exceeds the external bus bandwidth of the processor, the EIDMA, the EWDMA and the EODMA will compete for resources of the external bus bandwidth of the processor, which will inevitably cause one or two of the EIDMA, the EWDMA and the EODMA to be in a state of waiting for transmission, thus prolonging the time cost.

Therefore, for the first network layer of any one of the M network layer groups, if the sixth DMA unit (EWDMA) does not transmit the output data of the first network layer during a period that the first DMA unit transmits the input data of the first network layer and the second DMA unit (EWDMA) transmits the parameters of the first network layer, obtaining the first time information and the second time information, corresponding to the first network layer, includes:

step S31, determining a first average bandwidth that the first DMA unit transmits the input data, according to data quantity of the input data and the preset first transmission time.

Wherein the first transmission time is a time required for transmitting each data quantity unit (for example, 1024 bits) by the external bus of the processor.

For example, determining a transmission time that the EIDMA transmits the input data in the ideal situation (i.e., reading the input data from the external memory) according to the first transmission time required for the unit data quantity in the ideal situation and the data quantity of the input data. That is, the data quantity of the input data is divided by the unit data quantity, and then multiplied by the first transmission time to obtain the transmission time of the input data in the ideal situation. And then, determining the first average bandwidth according to the transmission time for transmitting the input data and the data quantity of the input data in the ideal situation. That is, the data quantity of the input data is divided by the transmission time for transmitting the input data in the ideal situation, so as to obtain the first average bandwidth.

Step S32, determining a second average bandwidth that the second DMA unit transmits a parameter according to a size of the parameter and the first transmission time.

Similarly, determining a transmission time that the EWDMA is configured to read the parameters from the external memory in the ideal situation, according to the first transmission time required for the unit data quantity in the ideal situation and the size of the parameter. And then, determining the second average bandwidth according to the transmission time for transmitting the parameters in the ideal situation and the data quantity of the parameters.

Step S33, if a sum of the first average bandwidth and the second average bandwidth is greater than the internal read-port bandwidth of the processor, obtaining a first correction coefficient.

If the sum of the first average bandwidth and the second average bandwidth is greater than the internal read-port bandwidth of the processor, it is indicated that the EIDMA and the EWDMA can compete for resources of the internal read-port bandwidth.

Furthermore, the first correction coefficient can be a preset fixed value, or can be calculated according to the sum of the first average bandwidth and the second average bandwidth, and the internal read-port bandwidth. For example, the first correction coefficient can be obtained by dividing the internal read-port bandwidth by the sum of the first average bandwidth and the second average bandwidth.

Step S34, correcting a time that the first DMA unit reads the parameters from the external memory, to obtain the first time information corresponding to the first network layer, according to the first correction coefficient.

Furthermore, correcting the time that the first DMA unit (i.e., the EIDMA) reads the input data from the external memory, is referred that a transmission time that the EIDMA external memory reads the input data in the ideal situation is corrected. As an example, the first time information can be obtained by calculating a product of the transmission time that the EIDMA external memory reads the input data in the ideal situation, and the first correction coefficient.

Step S35, correcting a time that the second DMA unit reads the parameters from the external memory, to obtain the second time information corresponding to the first network layer, according to the first correction coefficient.

Similarly, correcting the time that the second DMA unit (i.e., the EWDMA) reads the parameters from the external memory, is referred that a transmission time that the EWDMA external memory reads the parameters in the ideal situation is corrected. As an example, the second time information can be obtained by calculating a product of the transmission time that the EWDMA external memory reads the parameters in the ideal situation, and the first correction coefficient.

Understandably, in the example, the time cost is corrected by determining whether the EIDMA and the EWDMA compete for the resources of the internal read-port bandwidth of the processor. Thus, accuracy of estimating the time cost of the network processor can be improved.

Optionally, if the sixth DMA unit transmits the output data of the first network layer during a period that the first DMA unit transmits the input data of the first network layer and the second DMA unit transmits the parameters of the first network layer, obtaining the first time information, the second time information and the sixth time information, corresponding to the first network layer, includes:

step S41, determining the first average bandwidth that the first DMA unit transmits the input data, according to the data quantity of the input data and the preset first transmission time.

Step S42, determining the second average bandwidth that the second DMA unit transmits the parameter, according to the size of the parameter and the first transmission time.

Wherein the steps S41 and S42 can be referred to the descriptions of the steps S31 and S32 above, which will not be repeated here.

Step S43, determining a third average bandwidth that the sixth DMA unit transmits the output data, according to the data quantity of the output data and the first transmission time.

For example, determining the transmission time that the EIDMA transmits the output data in the ideal situation (i.e., reading the input data from the external memory) according to the first transmission time required for the unit data quantity in the ideal situation and the data quantity of the output data. That is, the data quantity of the output data is divided by the unit data quantity, and then multiplied by the first transmission time to obtain the transmission time of the output data in the ideal situation. And then, determining the third average bandwidth according to the transmission time for transmitting the output data in the ideal situation and the data quantity of the output data. That is, the data quantity of the output data is divided by the transmission time for transmitting the output data in the ideal situation, so as to obtain the third average bandwidth.

Step S44, if a sum of the first average bandwidth, the second average bandwidth and the third average bandwidth is greater than the external bandwidth of the processor, obtaining a second correction coefficient.

Understandably, if the sum of the first average bandwidth, the second average bandwidth and the third average bandwidth is greater than the external bus bandwidth, it is indicated that the EIDMA, the EWDMA and the EODMA will compete for resources of the external bandwidth of the processor, which will inevitably cause one or two of the EIDMA, the EWDMA and the EODMA to be in a state of waiting for transmission, thus prolonging the time cost of the processor.

Therefore, when the sum of the first average bandwidth, the second average bandwidth and the third average bandwidth is greater than the external bandwidth of the processor, the second correction coefficient can be obtained to correct the estimation time.

Furthermore, the second correction coefficient can be a preset fixed value, or can be calculated according to the sum of the first average bandwidth, the second average bandwidth and the third average bandwidth, and the external bandwidth. For example, the second correction coefficient can be obtained by dividing the external bus bandwidth by the sum of the first average bandwidth, the second average bandwidth and the third average bandwidth.

Step S45, correcting the time that the first DMA unit reads the parameters from the external memory, to obtain the first time information corresponding to the first network layer, according to the second correction coefficient.

The first time information can be obtained by multiplying the second correction coefficient by the time that the first DMA unit reads the parameters from the external memory.

Step S46, correcting the time that the second DMA unit reads the parameters from the external memory, to obtain the second time information, corresponding to the first network layer, according to the second correction coefficient.

For example, the second time information can be obtained by multiplying the second correction coefficient by the time that the second DMA unit reads the parameters from the external memory.

It should be noted that in the steps S45-S46, if the sum of the first average bandwidth and the second average bandwidth is less than or equal to the internal read-port bandwidth, the time that the first DMA unit reads the parameters from the external memory can be the time that the EIDMA reads the input data in the ideal situation, and the time that the second DMA unit reads the parameters from the external memory can be the time that the EWDMA reads the parameters in the ideal situation.

If the sum of the first average bandwidth and the second average bandwidth is greater than the internal read-port bandwidth of the processor, the time that the first DMA unit reads the parameters from the external memory can be, the time that the EIDMA reads the input data in the ideal situation and that has been corrected by the first correction coefficient. The time that the second DMA unit reads the parameters from the external memory can be, the time that the EWDMA reads the parameters in the ideal situation and that has been corrected by the first correction coefficient.

Step S47, correcting a time that the sixth DMA unit writes the output data to the external memory according to the second correction coefficient, to obtain the sixth time information corresponding to the first network layer.

For example, the third time information can be obtained by multiplying the second correction coefficient by the time that the EODMA reads the input data in the ideal situation.

Understandably, in the example, the time cost is corrected by determining whether the EIDMA, the EWDMA and the EODMA compete for resources of the external bus bandwidth of the processor. Thus, accuracy of estimating the time cost of the network processor can be improved.

In the method for calculating the runtime of the neural network on the processor of the present disclosure, after the neural network is compiled by the processor based on the tiling information, the processor is configured to perform the data read-write time information and the data processing time information of each network layer, when the neural network is compiled on the processor according to the tiling mode, a time value that the processor performs the neural network can be estimated. The time value of the processor corresponding to each tiling mode can be estimated without compiling the neural network based on such time cost estimation method. And then, a tiling mode with a part of relatively smaller time value or with a time value smaller than a time cost threshold can be selected from a large number of tiling modes for compiling and deploying to obtain a corresponding processor, based on the time value of each processor. Then the processor is measured to determine the tiling mode used by the processor with the optimal processing performance, rather than needing to compile each tiling mode one by one. Thus, the compilation efficiency can be greatly improved.

Based on the same inventive concept, as an implementation of the above method, a device for calculating a runtime of a neural network on a processor in accordance with an embodiment of the present disclosure is provided corresponding to the above method of the present disclosure. For conveniently understanding the present disclosure, details in the foregoing embodiment of the method are not repeated in the embodiment of the device one by one, but it should be clear that the device in the embodiment of the present disclosure can correspondingly implement all contents of the foregoing method.

Referring to FIG. 11, a schematic diagram of the device for calculating the runtime of the neural network on the processor in accordance with an embodiment of the present disclosure is provided and includes:

an evaluation unit configured to obtain data read-write time information and data processing time information of each network layer in a to-be-compiled neural network, according to tiling information of the neural network on the processor, and determine a time value of each network layer according to the data read-write time information and the data processing time information of each network layer; wherein the tiling information is configured to indicate that a plurality of network layers in the neural network are divided into M network layer groups, M is an integer more than and equal to one, and each network layer group includes at least one network layer.

A superposition unit is configured to add the time value of each network layer of the neural network, to obtain a time value of the processor for operating the neural network.

Optionally, for any one of the M network layer groups, if the network layer group includes N network layers, N is an integer greater than and equal to two.

The data read-write time information of a first network layer of the N network layers includes first time information, second time information, third time information, fourth time information and fifth time information, corresponding to the first network layer.

The data read-write time information of an i-th network layer of the N network layers includes third time information, fourth time information and fifth time information, corresponding to the i-th network layer; wherein i is an integer more than one and less than N.

The data read-write time information of an N-th network layer of the N network layers includes third time information, fourth time information, fifth time information and sixth time information, corresponding to the N-th network layer.

Furthermore, the first time information is configured to indicate a time that a first Direct Memory Access (DMA) unit in the processor transmits input data of a corresponding network layer from an external memory of the processor to an on-chip memory of the processor; the second time information configured to indicate a time that a second DMA unit in the processor transmits parameters of the corresponding network layer from the external memory to the on-chip memory; the third time information configured to indicate a time that a third DMA unit in the processor transmits the input data of the corresponding network layer from the on-chip memory to a cache of a PE in the processor; the fourth time information configured to indicate a time that a fourth DMA unit in the processor transmits the parameters of the corresponding network layer from the on-chip memory to the cache; the fifth time information configured to indicate a time that a fifth DMA unit in the processor transmits output data of the corresponding network layer from the cache to the on-chip memory; and the sixth time information configured to indicate a time that a sixth DMA unit in the processor transmits the output data of the corresponding network layer from the on-chip memory to the external memory.

Optionally, the evaluation unit 1101 configured to determine a time value of the first network layer, includes:

determining a first maximum value of the third time information, the fourth time information, and the data processing time information, corresponding to the first network layer; determining a second maximum value of one K-th of the first time information and one J-th of the second time information, corresponding to the first network layer; wherein K represents a preset number of handshakes between the first DMA unit and the external memory, K is an integer greater than and equal to one; J represents a preset number of handshakes between the second DMA unit and the external memory, J is an integer greater than and equal to one; and adding the first maximum value, the second maximum value and the fifth time information corresponding to the first network layer, to obtain the time value of the first network layer.

Optionally, the evaluation unit 1101 configured to determine a time value of the i-th network layer, includes: adding a maximum value of the third time information, the fourth time information and the data processing time information, and the fifth time information, corresponding to the i-th network layer, to obtain the time value of the i-th network layer.

Optionally, the evaluation unit 1101 configured to determine a time value of the N-th network layer, includes: adding a maximum value of the third time information, the fourth time information and the data processing time information, and the fifth time information and one L-th of the sixth time information, corresponding to the N-th network layer, to obtain the time value of the N-th network layer; wherein L represents a preset number of handshakes between the sixth DMA unit and the external memory, and L is an integer greater than and equal to one.

Optionally, if the input data of the i-th network layer includes output data of other network layers that do not belong to the network layer group, the data read-write information of the i-th network layer further includes first time information corresponding to the i-th network layer.

Optionally, the evaluation unit 1101 configured to determine the time value of the i-th network layer, includes: obtaining the time value of the i-th network layer by adding a maximum value of the third time information, the fourth time information and the data processing time information and one K-th of the first time information and the fifth time information, corresponding to the i-th network layer.

Optionally, for any one of the M network layer groups, if the network layer group includes a network layer, the data read-write time information of the network layer includes first time information, second time information, third time information, fourth time information, fifth time information and sixth time information, corresponding to the network layer.

Optionally, the evaluation unit 1101 configured to determine a time value of the network layer, includes: determining a third maximum value of the third time information, the fourth time information and the data processing time information, corresponding to the network layer; determining a fourth maximum value of one K-th of the first time information and one J-th of the second time information, corresponding to the network layer; wherein K represents a preset number of handshakes between the first DMA unit and the external memory, K is an integer greater than and equal to one; J represents a preset number of handshakes between the second DMA unit and the external memory, J is an integer greater than and equal to one; and obtaining the time value of the network layer by adding the third maximum value, the fourth maximum value, the fifth time information and one L-th of the sixth time information, corresponding to the network layer; wherein L represents a preset number of handshakes between the sixth DMA unit and the external memory, and L is an integer greater than and equal to one.

Optionally, for the first network layer of any one of the M network layer groups, if the sixth DMA unit does not transmit the output data of the first network layer during a period that the first DMA unit transmits the input data of the first network layer and the second DMA unit transmits the parameters of the first network layer, the evaluation unit 1101 configured to obtain the first time information and the second time information, corresponding to the first network layer, includes: determining a first average bandwidth that the first DMA unit transmits the input data, according to data quantity of the input data and a preset first transmission time; wherein the first transmission time is a time required for transmitting each data quantity unit by an external bus of the processor; determining a second average bandwidth that the second DMA unit transmits the parameter, according to a size of the parameter and the first transmission time; if a sum of the first average bandwidth and the second average bandwidth is greater than an internal read-port bandwidth of the processor, obtaining a first correction coefficient; correcting a time that the first DMA unit reads the parameters from the external memory according to the first correction coefficient, to obtain the first time information corresponding to the first network layer; and correcting a time that the second DMA unit reads the parameters from the external memory according to the first correction coefficient, to obtain the second time information corresponding to the first network layer.

Optionally, for the first network layer of any one of the M network layer groups, if the sixth DMA unit transmits the output data of the first network layer during the period that the first DMA unit transmits the input data of the first network layer and the second DMA unit transmits the parameters of the first network layer. The evaluation unit 1101 configured to obtain the first time information, the second time information and the sixth time information, corresponding to the first network layer, includes: determining the first average bandwidth of the input data transmitted by the first DMA unit according to the data quantity of the input data and the preset first transmission time; wherein the first transmission time is a time required for transmitting the unit data quantity by the external bus of the processor; determining the second average bandwidth of the parameter that the second DMA unit transmits the parameter, according to the size of the parameter and the first transmission time; determining a third average bandwidth that the sixth DMA unit transmits the output data, according to the data quantity of the output data and the first transmission time; if a sum of the first average bandwidth, the second average bandwidth and the third average bandwidth is greater than a bus bandwidth, obtaining a second correction coefficient; correcting a time that the first DMA unit reads the parameters from the external memory according to the second correction coefficient, to obtain the first time information corresponding to the first network layer; correcting a time that the second DMA unit reads the parameters from the external memory according to the second correction coefficient, to obtain the second time information corresponding to the first network layer; and correcting a time that the sixth DMA unit writes the output data to the external memory according to the second correction coefficient, to obtain the sixth time information corresponding to the first network layer.

Optionally, for any network layer of the neural network, the evaluation unit 1101 configured to obtain the data processing time information corresponding to the network layer, includes: determining original processing element (PE) groups of the processor and the number of output feature maps required to be calculated by each PE group, according to a size of an input feature map and the number of output feature channels of the network layer, each PE group including at least one PE; determining seventh time information that the PE group calculates the output feature map, according to a size of the output feature map and a size of a preset convolution kernel; and obtaining the data processing time information corresponding to the network layer, according to the seventh time information and the number of output feature maps required to be calculated by the PE group.

Optionally, for any network layer of the neural network, the evaluation unit 1101 configured to obtain the fourth time information corresponding to the network layer, includes: determining the original PE groups processed by the processor according to the size of the input feature map, each PE group including at least one PE; determining a size of parameters of the network layer, according to the number of input feature channels and the number of output feature channels of the network layer and the number of the PE groups; and determining the fourth time information corresponding to the network layer, according to an internal bus bandwidth and the size of parameters.

The device for calculating a runtime of a neural network on a processor provided in this embodiment can perform the above embodiments of the method, and its implementation principle and technical effect are similar to that of the method, which will not be repeated here.

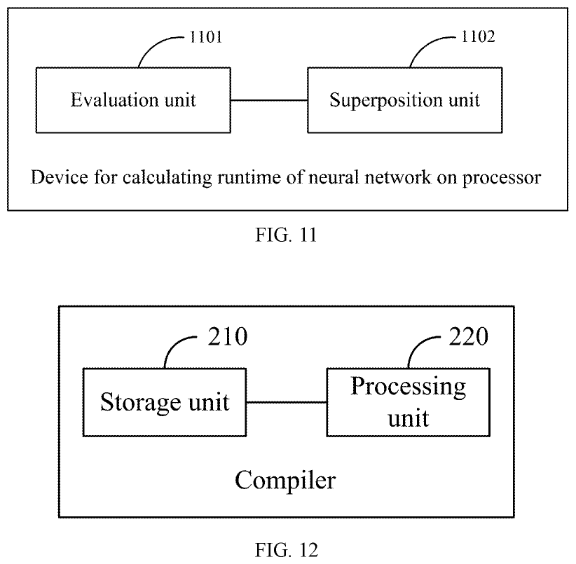

Based on the same inventive concept, a compiler according to an embodiment of the present disclosure is provided. FIG. 12 is a schematic diagram of a compiler in accordance with an embodiment of the present disclosure. Referring to FIG. 12, the compiler includes: a storage unit 120 configured to store computer programs, and a processor 220 configured to perform the computer programs to implement the method described in the embodiments of the present disclosure above mentioned.

The compiler provided according to the embodiment can perform the above embodiments of the method, and its implementation principle and technical effect are similar to that of the method, which will not be repeated here.

A computer readable storage medium according to an embodiment of the present disclosure is configured to store computer programs performed by a processor to implement the method described in the embodiments of the present disclosure above mentioned.

An ordinary skilled person in the art can be clearly understood that the embodiments of the present disclosure can be provided for methods, systems, or computer program products. Therefore, the present disclosure disclosed herein can be implemented through an embodiment of full hardware, an embodiment of software or an embodiment of combining hardware and software. Furthermore, the present disclosure can be in the form of a computer program product implemented on one or more computer available storage mediums in which computer available program codes is contained.

The processing unit can be a Central Processing Unit (CPU), other general-purpose processors, a Digital Signal Processor (DSP), an Application Specific Integrated Circuit (ASIC), a Field-Programmable Gate Array (FPGA) or other programmable logic devices, discrete gates or transistor logic devices, discrete hardware components, etc. The general-purpose processor can be a microprocessor or any conventional processors, etc.

The storage unit can include a non-permanent memory in a computer readable medium, a Random Access Memory (RAM), and/or a non-volatile memory, such as a Read-Only Memory (ROM) or a flash RAM. The memory is an example of a computer readable medium.

A computer readable medium can include a permanent and non-permanent, removable and non-removable storage medium. The storage medium can be used by any method or technologies to store information, which can be computer readable instructions, data structures, modules of programs, or other data. Examples of the computer storage medium including, but not limited to, a Phase Change Memory (PRAM), a Static Random Access Memory (SRAM) and a Dynamic Random Access Memory (DRAM), and other types of random access memory (RAM), a Read-Only Memory (ROM), in addition to an Electrical Erasable Programmable Read Only Memory (EEPROM), a flash memory, or other memory technologies, a Read-Only Memory (CD-ROM), a versatile disc (DVD) or other optical storages, magnetic tape cassettes, disk storages or other magnetic storage devices or any other non-transmission mediums, can be used to store information that can be accessed by computing devices. As defined in the present disclosure, the computer readable medium does not include a computer readable transitory media, such as modulated data signals and carriers.

Finally, it should be noted that: the above embodiments are used only to describe, but not limited to, the technical solution of the present disclosure. Although the features and elements of the present disclosure are described as embodiments in particular combinations, an ordinary skilled person in the art should understand that: each feature or element can be used alone or in other various combinations within the principles of the present disclosure to the full extent indicated by the broad general meaning of the terms in which the appended claims are expressed. Any variation or replacement made by one of ordinary skill in the art without departing from the spirit of the present disclosure shall fall within the protection scope of the present disclosure.

What is claimed is:

1. A method for calculating a runtime of a neural network on a processor comprising:
obtaining data read-write time information and data processing time information of each network layer in a to-be-compiled neural network, according to tiling information of the neural network on a processor, and determining a time value of each network layer according to the data read-write time information and the data processing time information of each network layer; wherein the tiling information is configured to indicate that a plurality of network layers in the neural network are divided into M network layer groups, M is an integer more than and equal to one, and each network layer group comprises at least one network layer; and
adding the time value of each network layer of the neural network to obtain a time value of the processor for operating the neural network; and wherein for any network layer of the neural network, obtaining the data processing time information corresponding to the network layer, comprises:
determining original processing element (PE) groups of the processor and the number of output feature maps required to be calculated by each PE group, according to a size of an input feature map and the number of output feature channels of the network layer, each PE group comprising at least one PE;
determining seventh time information that the PE group calculates the output feature map, according to a size of the output feature map and a size of a preset convolution kernel; and
obtaining the data processing time information corresponding to the network layer, according to the seventh time information and the number of output feature maps required to be calculated by the PE group.

2. The method as claimed in claim 1, wherein for any one of the M network layer groups, if the network layer group comprises N network layers, N is an integer greater than and equal to two, comprising:
the data read-write time information of a first network layer of the N network layers comprising first time information, second time information, third time information, fourth time information and fifth time information, corresponding to the first network layer;
the data read-write time information of an i-th network layer of the N network layers comprising third time information, fourth time information and fifth time information, corresponding to the i-th network layer; wherein i is an integer more than one and less than N;
the data read-write time information of an N-th network layer of the N network layers comprising third time information, fourth time information, fifth time information and sixth time information, corresponding to the N-th network layer; and wherein
the first time information is configured to indicate a time that a first Direct Memory Access (DMA) unit in the processor transmits input data of a corresponding network layer from an external memory of the processor to an on-chip memory of the processor; the second time information configured to indicate a time that a second DMA unit in the processor transmits parameters of the corresponding network layer from the external memory to the on-chip memory; the third time information configured to indicate a time that a third DMA unit in the processor transmits the input data of the corresponding network layer from the on-chip memory to a cache of a PE in the processor; the fourth time information configured to indicate a time that a fourth DMA unit in the processor transmits the parameters of the corresponding network layer from the on-chip memory to the cache; the fifth time information configured to indicate a time that a fifth DMA unit in the processor transmits output data of the corresponding network layer from the cache to the on-chip memory; and the sixth time information configured to indicate a time that a sixth DMA unit in the processor transmits the output data of the corresponding network layer from the on-chip memory to the external memory.

3. The method as claimed in claim 2, wherein determining a time value of the first network layer, comprises:
determining a first maximum value of the third time information, the fourth time information, and the data processing time information, corresponding to the first network layer;
determining a second maximum value of one K-th of the first time information and one J-th of the second time information, corresponding to the first network layer; wherein K represents a preset number of handshakes between the first DMA unit and the external memory, K is an integer greater than and equal to one; J represents a preset number of handshakes between the second DMA unit and the external memory, J is an integer greater than and equal to one; and
adding the first maximum value, the second maximum value and the fifth time information, corresponding to the first network layer, to obtain the time value of the first network layer.

4. The method as claimed in claim 2, wherein determining a time value of the i-th network layer, comprises:
adding a maximum value of the third time information, the fourth time information and the data processing time information, and the fifth time information, corresponding to the i-th network layer, to obtain the time value of the i-th network layer.

5. The method as claimed in claim 2, wherein determining a time value of the N-th network layer, comprises:
adding a maximum value of the third time information, the fourth time information and the data processing time information, and the fifth time information and one L-th of the sixth time information, corresponding to the N-th network layer, to obtain the time value of the N-th network layer;
wherein L represents a preset number of handshakes between the sixth DMA unit and the external memory, and L is an integer greater than and equal to one.

6. The method as claimed in claim 2, wherein if the input data of the i-th network layer comprises output data of other network layers that do not belong to the network layer group, the data read-write information of the i-th network layer further comprises first time information corresponding to the i-th network layer.

7. The method as claimed in claim 6, wherein determining a time value of the i-th network layer, comprises:
obtaining the time value of the i-th network layer by adding a maximum value of the third time information, the fourth time information and the data processing time information, and one K-th of the first time information and the fifth time information, corresponding to the i-th network layer; wherein K represents a preset number of handshakes between the first DMA unit and the external memory.

8. The method as claimed in claim 1, wherein for any one of the M network layer groups, if the network layer group comprises a network layer, the data read-write time information of the network layer comprises first time information, second time information, third time information, fourth time information, fifth time information and sixth time information, corresponding to the network layer; and wherein
the first time information is configured to indicate a time that a first Direct Memory Access (DMA) unit in the processor transmits input data of the network layer from an external memory of the processor to an on-chip memory of the processor; the second time information configured to indicate a time that a second DMA unit in the processor transmits parameters of the network layer from the external memory to the on-chip memory; the third time information configured to indicate a time that a third DMA unit in the processor transmits the input data from the on-chip memory to a cache of a PE in the processor; the fourth time information configured to indicate a time that a fourth DMA unit in the processor transmits the parameters from the on-chip memory to the cache; the fifth time information configured to indicate a time that a fifth DMA unit in the processor transmits output data of the network layer from the cache to the on-chip memory; and the sixth time information configured to indicate a time that a sixth DMA unit in the processor transmits the output data from the on-chip memory to the external memory.

9. The method as claimed in claim 8, wherein determining a time value of the network layer comprises:
determining a third maximum value of the third time information, the fourth time information and the data processing time information, corresponding to the network layer;
determining a fourth maximum value of one K-th of the first time information and one J-th of the second time information, corresponding to the network layer; wherein K represents a preset number of handshakes between the first DMA unit and the external memory, K is an integer greater than and equal to one; J represents a preset number of handshakes between the second DMA unit and the external memory, J is an integer greater than and equal to one; and
obtaining the time value of the network layer by adding the third maximum value, the fourth maximum value, the fifth time information and the one L-th of the sixth time information, corresponding to the network layer; wherein L represents a preset number of handshakes between the sixth DMA unit and the external memory, and L is an integer greater than and equal to one.

10. The method as claimed in claim 2, wherein for the first network layer of any one of the M network layer groups, if the sixth DMA unit does not transmit the output data of the first network layer during a period that the first DMA unit transmits the input data of the first network layer and the second DMA unit transmits the parameters of the first network layer, obtaining the first time information and the second time information, corresponding to the first network layer, comprising:
determining a first average bandwidth that the first DMA unit transmits the input data, according to data quantity of the input data and a preset first transmission time; wherein the first transmission time is a time required for transmitting each data quantity unit by an external bus of the processor;
determining a second average bandwidth that the second DMA unit transmits the parameter, according to a size of the parameter and the first transmission time;
if a sum of the first average bandwidth and the second average bandwidth is greater than an internal read-port bandwidth of the processor, obtaining a first correction coefficient;
correcting a time that the first DMA unit reads the parameters from the external memory according to the first correction coefficient, to obtain the first time information corresponding to the first network layer; and
correcting a time that the second DMA unit reads the parameters from the external memory according to the first correction coefficient, to obtain the second time information corresponding to the first network layer.

11. The method as claimed in claim 2, wherein for the first network layer of any one of the M network layer groups, if the sixth DMA unit transmits the output data of the first network layer during a period that the first DMA unit transmits the input data of the first network layer and the second DMA unit transmits the parameters of the first network layer, obtaining the first time information, the second time information and the sixth time information, corresponding to the first network layer, comprising:
determining a first average bandwidth that the first DMA unit transmits the input data, according to data quantity of the input data and a preset first transmission time; wherein the first transmission time is a time required for transmitting each data quantity unit by an external bus of the processor;
determining a second average bandwidth that the second DMA unit transmits the parameter, according to a size of the parameter and the first transmission time;
determining a third average bandwidth that the sixth DMA unit transmits the output data, according to data quantity of the output data and the first transmission time;
if a sum of the first average bandwidth, the second average bandwidth and the third average bandwidth is greater than a bus bandwidth, obtaining a second correction coefficient;
correcting a time that the first DMA unit reads the parameters from the external memory according to the second correction coefficient, to obtain the first time information corresponding to the first network layer;
correcting a time that the second DMA unit reads the parameters from the external memory according to the second correction coefficient, to obtain the second time information corresponding to the first network layer; and
correcting a time that the sixth DMA unit writes the output data to the external memory according to the second correction coefficient, to obtain the sixth time information corresponding to the first network layer.

12. The method as claimed in claim 2, wherein for any network layer of the neural network, obtaining the fourth time information corresponding to the network layer, comprises:
determining PE groups of the processor, according to a size of an input feature map of the network layer, each PE group comprising at least one PE;
determining a size of parameters of the network layer, according to the number of input feature channels and the number of output feature channels of the network layer and the number of the PE groups; and
determining the fourth time information corresponding to the network layer, according to an internal bus bandwidth and the size of parameters.

13. A device for calculating a runtime of a neural network on a processor comprising:
an evaluation unit configured to obtain data read-write time information and data processing time information of each network layer in a to-be-compiled neural network, according to tiling information of the neural network on the processor, and determine a time value of each network layer according to the data read-write time information and the data processing time information of each network layer; wherein the tiling information is configured to indicate that a plurality of network layers in the neural network are divided into M network layer groups, M is an integer more than and equal to one, and each network layer group comprises at least one network layer; and
a superposition unit configured to add the time value of each network layer of the neural network, to obtain a time value of the processor for operating the neural network; and wherein for any network layer of the neural network, obtaining the data processing time information corresponding to the network layer, comprises:
determining original processing element (PE) groups of the processor and the number of output feature maps required to be calculated by each PE group, according to a size of an input feature map and the number of output feature channels of the network layer, each PE group comprising at least one PE;
determining seventh time information that the PE group calculates the output feature map, according to a size of the output feature map and a size of a preset convolution kernel; and
obtaining the data processing time information corresponding to the network layer, according to the seventh time information and the number of output feature maps required to be calculated by the PE group.

14. A complier comprising a storage unit configured to store computer programs, and a processing unit configured to invoke the computer programs and perform the computer programs to implement a method for calculating a runtime of a neural network on a processor, the method comprising:
obtaining data read-write time information and data processing time information of each network layer in a to-be-compiled neural network, according to tiling information of the neural network on a processor, and determining a time value of each network layer according to the data read-write time information and the data processing time information of each network layer; wherein the tiling information is configured to indicate that a plurality of network layers in the neural network are divided into M network layer groups, M is an integer more than and equal to one, and each network layer group comprises at least one network layer; and
adding the time value of each network layer of the neural network to obtain a time value of the processor for operating the neural network; and wherein for any network layer of the neural network, obtaining the data processing time information corresponding to the network layer, comprises:
determining original processing element (PE) groups of the processor and the number of output feature maps required to be calculated by each PE group, according to a size of an input feature map and the number of output feature channels of the network layer, each PE group comprising at least one PE;
determining seventh time information that the PE group calculates the output feature map, according to a size of the output feature map and a size of a preset convolution kernel; and
obtaining the data processing time information corresponding to the network layer, according to the seventh time information and the number of output feature maps required to be calculated by the PE group.
